(19) United States
(12) Patent Application Publication
(10) Pub. No.: US 2012/0233345 A1
(43) Pub. Date: Sep. 13, 2012

(54) METHOD AND APPARATUS FOR ADAPTIVE STREAMING

(75) Inventor: Miska Matias HANNUKSELA, Ruutana (FI)

(73) Assignee: NOKIA CORPORATION, Espoo (FI)

(21) Appl. No.: 13/230,425

(22) Filed: Sep. 12, 2011

Related U.S. Application Data
(60) Provisional application No. 61/381,533, filed on Sep. 10, 2010.

(51) Int. Cl. G06F 15/16

(52) U.S. Cl. 709/231

(57) ABSTRACT

There is disclosed a method, apparatus and computer program product for adaptive streaming. At least one file comprising media data is generated, wherein a first segment and a second segment are received, and a first instruction and a second instruction are received. The first segment and the second segment are modified on the basis of the first instruction and the second instruction. The at least one file is created on the basis of the modified first segment and the modified second segment.

### TECHNICAL FIELD

The present invention relates to adaptive streaming to provide digital media from a server to a client.

### BACKGROUND INFORMATION

Progressive download is a term used to describe the transfer of digital media files from a server to a client device, typically using a hypertext transfer protocol (HTTP) when initiated from the client device. A consumer may begin playback of the digital media file by the client device before the download is complete. One difference between streaming media and progressive download is in how the digital media data is received and stored by the client device that is accessing the digital media.

A media player that is capable of progressive download playback of a file containing digital media relies on meta data located in a header of the file to be intact and a local buffer for the digital media file as it is downloaded from a web server. At the point in which a specified amount of data becomes available to the local playback device, the media player will begin to play the digital media file. Information on this specified amount of buffer may be embedded into the digital media file by the producer of the content and may be reinforced by additional buffer settings imposed by the media player.

The end user experience of the progressive download of a digital media file may be similar to a streaming media, however the digital media file is downloaded to a physical storage medium on the end user's device, for example to a hard disk drive or to another kind of non-volatile memory. The digital media file may be stored in a temporary folder of the associated web browser if the digital media file was embedded into a web page or is diverted to a storage directory that is set in the preferences of the media player used for the playback. The play back of the digital media file may not be continuous and fluent i.e. the play back may stutter or the play back may even be stopped if the rate of the play back exceeds the rate at which the digital media file is downloaded. The digital media file may then begin to play again after the download proceeds further.

The metadata as well as media data in the files intended for progressive download may be interleaved in such a manner that the media data of different streams is interleaved in the file and the streams are synchronized approximately. Furthermore, metadata is often interleaved with media data so that the initial buffering delay required for receiving the metadata located at the beginning of the file may be reduced. An example of how the base media file format of the International Organization for Standardization (ISO Base Media File Format) and its derivative formats can be restricted to be progressively downloadable is the progressive download profile of the file format of the Third Generation Partnership Project (3GPP file format).

### SUMMARY OF SOME EXAMPLE EMBODIMENTS

In some example embodiments of the invention an (ordered) sequence of instructions may be used which indicate to the receiving device how to compose a file from received segments. The instructions may be created at the time of content creation, but may also be created later on. The instructions may be available in or to the server from which the segment stream(s) can be transmitted using e.g. HTTP to the receiving device. The instructions may also be available in a server separate from the http server sending the media segments. Such a receiving device is also called as a HTTP streaming client in this application. Different combinations of representations of the media data may have different instruction sequences, and a particular representation switching may be associated with a particular sequence of instructions. Hence, the server file may contain or is associated with a number of instruction sequences with switch points between the instruction sequences. The instructions can be requested by an HTTP streaming client or the instructions may be included in transport format segments without an explicit request. By following the instructions, the HTTP streaming client can compose a valid media file which may be an ISO base media file or MP4 file or 3GP file or any other derivative file of the ISO base media file format.

Some example embodiments of the invention facilitate conversion of segments of the media data received through adaptive HTTP streaming to a file that can be played by so called legacy file players. A legacy file player is capable of parsing and playing a file formatted according to a file format, such as 3GPP file format, but need not be capable of parsing and playing segments of HTTP streaming. Using prior art methods the creation of such files may require capability of re-writing the file metadata. Thus, some example embodiments of the invention simplify the processing in adaptive HTTP streaming client. Furthermore, the invention facilitates playback of media data received through adaptive HTTP streaming with legacy players and hence improves the successful interchange of recorded files between devices.

According to a first aspect of the present invention there is provided a method for generating at least one file comprising media data, wherein

a first segment and a second segment are received,

a first instruction and a second instruction are received,

the first segment and the second segment are modified on the basis of the first instruction and the second instruction,

the at least one file is created on the basis of the modified first segment and the modified second segment.

According to a second aspect of the present invention there is provided an apparatus comprising:

a first input configured for receiving a first segment and a second segment;

a second input configured for receiving a first instruction and a second instruction;

a modifier configured for modifying the first segment and the second segment on the basis of the first instruction and the second instruction; and

a file creator configured for creating at least one file on the basis of the modified first segment and the modified second segment.

According to a third aspect of the present invention there is provided a computer readable storage medium stored with code thereon for use by an apparatus, which when executed by a processor, causes an apparatus to generate at least one file comprising media data, wherein the computer program product further comprises computer code to cause the apparatus to:

receive a first segment and a second segment,

receive a first instruction and a second instruction,

modify the first segment and the second segment on the basis of the first instruction and the second instruction,

create the at least one file on the basis of the modified first segment and the modified second segment.

According to a fourth aspect of the present invention there is provided at least one processor and at least one memory, said at least one memory stored with code thereon, which when executed by said at least one processor, causes an apparatus to perform:

receiving a first segment and a second segment,

receiving a first instruction and a second instruction,

modifying the first segment and the second segment on the basis of the first instruction and the second instruction,

creating the at least one file on the basis of the modified first segment and the modified second segment.

According to a fifth aspect of the present invention there is provided a method for generating a first instruction and a second instruction, wherein

a first segment and a second segment are recognized,

the first instruction and the second instruction are created to indicate at least one modification of the first segment and the second segment such that at least one file can be created on the basis of the modified first segment and the modified second segment.

According to a sixth aspect of the present invention there is provided an apparatus comprising:

a recognizer configured for recognizing a first segment and a second segment;

a creator configured for creating a first instruction and a second instruction to indicate at least one modification of the first segment and the second segment such that at least one file can be created on the basis of the modified first segment and the modified second segment.

According to a seventh aspect of the present invention there is provided a computer readable storage medium stored with code thereon for use by an apparatus, which when executed by a processor, causes an apparatus to generate a first instruction and a second instruction, wherein the computer program product further comprises computer code to cause the apparatus to:

recognize a first segment and a second segment;

create a first instruction and a second instruction to indicate at least one modification of the first segment and the second segment such that at least one file can be created on the basis of the modified first segment and the modified second segment.

According to an eighth aspect of the present invention there is provided at least one processor and at least one memory, said at least one memory stored with code thereon, which when executed by said at least one processor, causes an apparatus to perform:

recognizing a first segment and a second segment;

creating a first instruction and a second instruction to indicate at least one modification of the first segment and the second segment such that at least one file can be created on the basis of the modified first segment and the modified second segment.

According to a ninth aspect of the present invention there is provided a method for indicating a first resource locator for a first instruction and a second resource locator for a second instruction, wherein

a first segment and a second segment are recognized,

the first instruction and the second instruction are recognized, the first instruction and the second instruction indicating at least one modification of the first segment and the second segment such that at least one file can be created on the basis of the modified first segment and the modified second segment,

associating the first resource locator to the first instruction and associating the second resource locator to the second instruction, and

indicating the first resource locator and the second resource locator in a media presentation description.

According to a tenth aspect of the present invention there is provided an apparatus comprising:

a first element configured for recognizing a first segment and a second segment;

a second element configured for recognizing a first instruction and a second instruction, the first instruction and the second instruction indicating at least one modification of the first segment and the second segment such that at least one file can be created on the basis of the modified first segment and the modified second segment;

a third element configured for associating the first resource locator to the first instruction and associating the second resource locator to the second instruction, and

a fourth element configured for indicating the first resource locator and the second resource locator in a media presentation description.

According to an eleventh aspect of the present invention there is provided a computer readable storage medium stored with code thereon for use by an apparatus, which when executed by a processor, causes an apparatus to indicate a first resource locator for a first instruction and a second resource locator for a second instruction, wherein the computer program product further comprises computer code to cause the apparatus to:

recognize a first segment and a second segment;

recognize a first instruction and a second instruction, the first instruction and the second instruction indicating at least one modification of the first segment and the second segment such that at least one file can be created on the basis of the modified first segment and the modified second segment;

associate the first resource locator to the first instruction and associating the second resource locator to the second instruction, and

indicate the first resource locator and the second resource locator in a media presentation description.

According to a twelfth aspect of the present invention there is provided an apparatus which comprises:

means for receiving a first segment and a second segment;

means for receiving a first instruction and a second instruction;

means for modifying the first segment and the second segment on the basis of the first instruction and the second instruction; and

means for creating at least one file on the basis of the modified first segment and the modified second segment.

According to a thirteenth aspect of the present invention there is provided an apparatus which comprises:

means for recognizing a first segment and a second segment;

means for creating a first instruction and a second instruction to indicate at least one modification of the first segment and the second segment such that at least one file can be created on the basis of the modified first segment and the modified second segment.

### DESCRIPTION OF THE DRAWINGS

FIG. 1 depicts an example illustration of some functional blocks, formats, and interfaces included in an HTTP streaming system;

FIG. 2 depicts an example of a file structure for server file format where one file contains metadata fragments constituting the entire duration of a presentation;

FIG. 3 illustrates an example of a regular web server operating as a HTTP streaming server;

FIG. 4 illustrates an example of a regular web server connected with a dynamic streaming server;

FIG. 5 illustrates an example of a multimedia file format hierarchy;

FIG. 6 illustrates an example of a simplified structure of an ISO file;

FIG. 7 depicts an example of a media presentation data model;

FIG. 8 depicts an example of a media presentation description XML schema;

FIG. 9 depicts an example of an apparatus for the streaming client;

FIG. 10 depicts an example of an apparatus for the streaming server;

FIG. 11 depicts an example of an apparatus for the content provider;

FIG. 12 depicts a flow diagram of an example method for the streaming client;

FIG. 13 depicts a flow diagram of an example method for the content provider;

FIG. 14 illustrates a block diagram of an example embodiment of a mobile terminal.

### DETAILED DESCRIPTION

Some embodiments will now be described more fully hereinafter with reference to the accompanying drawings, in which some, but not all embodiments are shown. Indeed, various embodiments may be embodied in many different forms and should not be construed as limited to the embodiments set forth herein; rather, these embodiments are provided so that this disclosure will satisfy applicable legal requirements Like reference numerals refer to like elements throughout. As used herein, the terms “data,” “content,” “information” and similar terms may be used interchangeably to refer to data capable of being transmitted, received and/or stored in accordance with embodiments. Thus, use of any such terms should not be taken to limit the spirit and scope of various embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a nontransitory, physical storage medium (e.g., volatile or non-volatile memory device), can be differentiated from a “computer-readable transmission medium,” which refers to an electromagnetic signal.

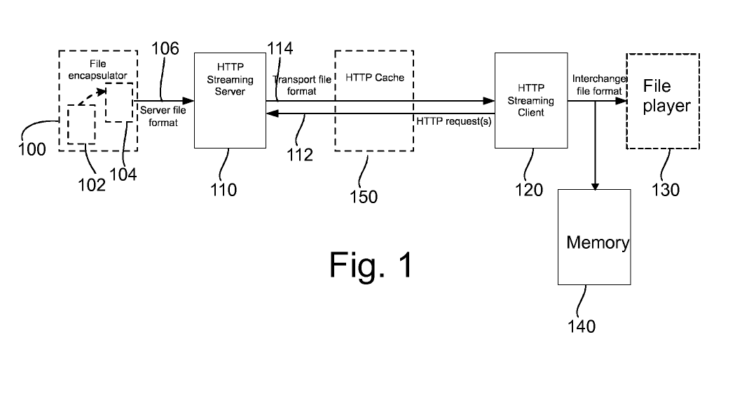

In FIG. 1 an example illustration of some functional blocks, formats, and interfaces included in a hypertext transfer protocol (HTTP) streaming system are shown. A file encapsulator 100 takes media bitstreams of a media presentation as input. The bitstreams may already be encapsulated in one or more container files 102. The bitstreams may be received by the file encapsulator 100 while they are being created by one or more media encoders. The file encapsulator converts the media bitstreams into one or more files 104, which can be processed by a streaming server 110 such as the HTTP streaming server. The output 106 of the file encapsulator is formatted according to a server file format. The HTTP streaming server 110 may receive requests from a streaming client 120 such as the HTTP streaming client. The requests may be included in a message or messages according to e.g. the hypertext transfer protocol such as a GET request message. The request may include an address indicative of the requested media stream. The address may be the so called uniform resource locator (URL). The HTTP streaming server 110 may respond to the request by transmitting the requested media file(s) and other information such as the metadata file(s) to the HTTP streaming client 120. The HTTP streaming client 120 may then convert the media file(s) to a file format suitable for play back by the HTTP streaming client and/or by a media player 130. The converted media data file(s) may also be stored into a memory 140 and/or to another kind of storage medium. The HTTP streaming client and/or the media player may include or be operationally connected to one or more media decoders, which may decode the bitstreams contained in the HTTP responses into a format that can be rendered.

### Server File Format

A server file format is used for files that the HTTP streaming server 110 manages and uses to create responses for HTTP requests. There may be, for example, the following three approaches for storing media data into file(s).

In a first approach a single metadata file is created for all versions. The metadata of all versions (e.g. for different bitrates) of the content (media data) resides in the same file. The media data may be partitioned into fragments covering certain playback ranges of the presentation. The media data can reside in the same file or can be located in one or more external files referred to by the metadata.

In a second approach one metadata file is created for each version. The metadata of a single version of the content resides in the same file. The media data may be partitioned into fragments covering certain playback ranges of the presentation. The media data can reside in the same file or can be located in one or more external files referred to by the metadata.

In a third approach one file is created per each fragment. The metadata and respective media data of each fragment covering a certain playback range of a presentation and each version of the content resides in their own files. Such chunking of the content to a large set of small files may be used in a possible realization of static HTTP streaming. For example, chunking of a content file of duration 20 minutes and with 10 possible representations (5 different video bitrates and 2 different audio languages) into small content pieces of 1 second, would result in 12000 small files. This constitutes a burden on web servers, which has to deal with such a large amount of small files.

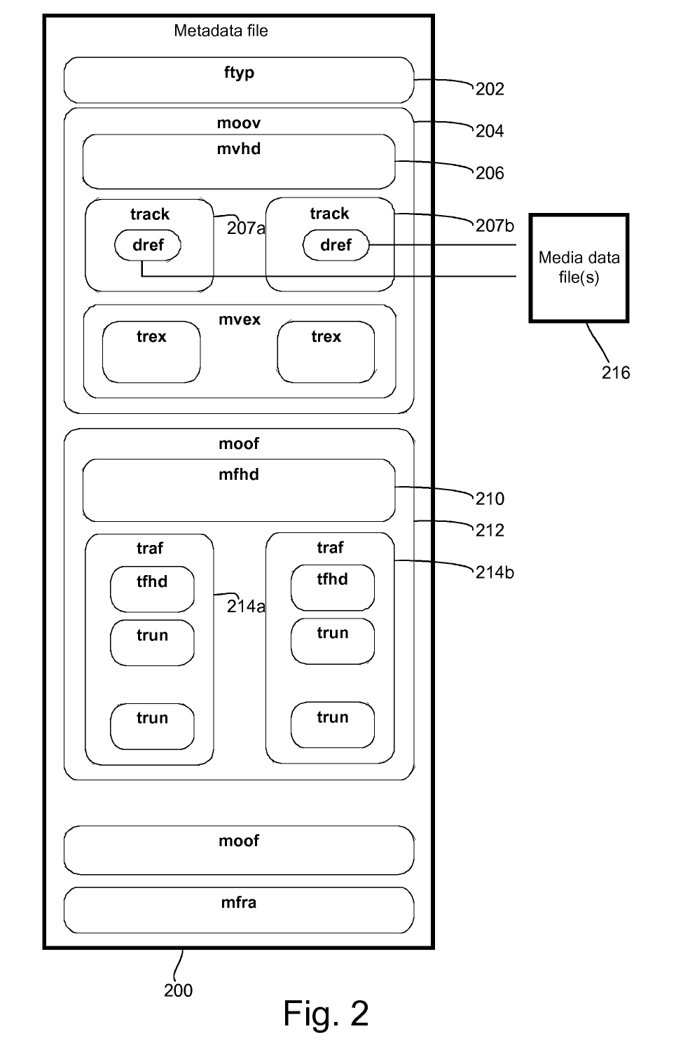

The first and the second approach i.e. a single metadata file for all versions and one metadata file for each version, respectively, are illustrated in FIG. 2 using the structures of the ISO base media file format. In the example of FIG. 2, the metadata is stored separately from the media data, which is stored in external file(s). The metadata is partitioned into fragments 207a, 214a; 207b, 214b covering a certain playback duration. If the file contains tracks 207a, 207b that are alternatives to each other, such as the same content coded with different bitrates, FIG. 2 illustrates the case of a single metadata file for all versions; otherwise, it illustrates the case of one metadata file for each version.

### HTTP Streaming Server

A HTTP streaming server 110 takes one or more files of a media presentation as input. The input files are formatted according to a server file format. The HTTP streaming server 110 responds 114 to HTTP requests 112 from a HTTP streaming client 120 by encapsulating media in HTTP responses. The HTTP streaming server outputs and transmits a file or many files of the media presentation formatted according to a transport file format and encapsulated in HTTP responses.

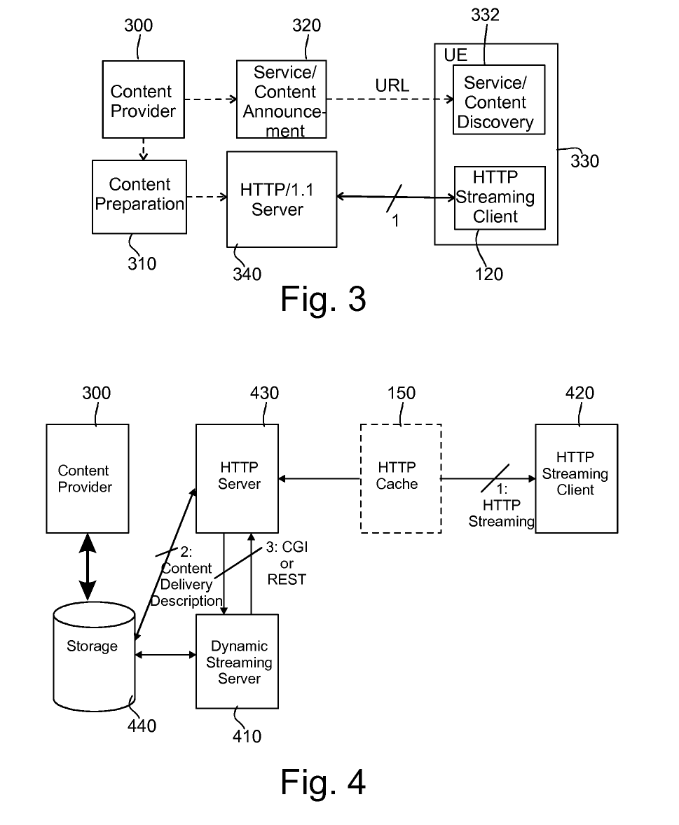

In some embodiments the HTTP streaming servers 110 can be coarsely categorized into three classes. The first class is a web server, which is also known as a HTTP server, in a “static” mode. In this mode, the HTTP streaming client 120 may request one or more of the files of the presentation, which may be formatted according to the server file format, to be transmitted entirely or partly. The server is not required to prepare the content by any means. Instead, the content preparation is done in advance, possibly offline, by a separate entity. FIG. 3 illustrates an example of a web server as a HTTP streaming server. A content provider 300 may provide a content for content preparation 310 and an announcement of the content to a service/content announcement service 320. The user device 330, which may contain the HTTP streaming client 120, may receive information regarding the announcements from the service/content announcement service 320 wherein the user of the user device 330 may select a content for reception. The service/content announcement service 320 may provide a web interface and consequently the user device 330 may select a content for reception through a web browser in the user device 330. Alternatively or in addition, the service/content announcement service 320 may use other means and protocols such as the Service Advertising Protocol (SAP), the Really Simple Syndication (RSS) protocol, or an Electronic Service Guide (ESG) mechanism of a broadcast television system. The user device 330 may contain a service/content discovery element 332 to receive information relating to services/contents and e.g. provide the information to a display of the user device. The streaming client 120 may then communicate with the web server 340 to inform the web server 340 of the content the user has selected for downloading. The web server 340 may the fetch the content from the content preparation service 310 and provide the content to the HTTP streaming client 120.

The second class is a (regular) web server operationally connected with a dynamic streaming server as illustrated in FIG. 4. The dynamic streaming server 410 dynamically tailors the streamed content to a client 420 based on requests from the client 420. The HTTP streaming server 430 interprets the HTTP GET request from the client 420 and identifies the requested media samples from a given content. The HTTP streaming server 430 then locates the requested media samples in the content file(s) or from the live stream. It then extracts and envelopes the requested media samples in a container 440. Subsequently, the newly formed container with the media samples is delivered to the client in the HTTP GET response body.

The first interface “1” in FIGS. 3 and 4 is based on the HTTP protocol and defines the syntax and semantics of the HTTP Streaming requests and responses. The HTTP Streaming requests/responses may be based on the HTTP GET requests/responses.

The second interface “2” in FIG. 4 enables access to the content delivery description. The content delivery description, which may also be called as a media presentation description, may be provided by the content provider 450 or the service provider. It gives information about the means to access the related content. In particular, it describes if the content is accessible via HTTP Streaming and how to perform the access. The content delivery description is usually retrieved via HTTP GET requests/responses but may be conveyed by other means too, such as by using SAP, RSS, or ESG.

The third interface “3” in FIG. 4 represents the Common Gateway Interface (CGI), which is a standardized and widely deployed interface between web servers and dynamic content creation servers. Other interfaces such as a representational State Transfer (REST) interface are possible and would enable the construction of more cache-friendly resource locators.

The Common Gateway Interface (CGI) defines how web server software can delegate the generation of web pages to a console application. Such applications are known as CGI scripts; they can be written in any programming language, although scripting languages are often used. One task of a web server is to respond to requests for web pages issued by clients (usually web browsers) by analyzing the content of the request, determining an appropriate document to send in response, and providing the document to the client. If the request identifies a file on disk, the server can return the contents of the file. Alternatively, the content of the document can be composed on the fly. One way of doing this is to let a console application compute the document's contents, and inform the web server to use that console application. CGI specifies which information is communicated between the web server and such a console application, and how.

The representational State Transfer is a style of software architecture for distributed hypermedia systems such as the World Wide Web (WWW). REST-style architectures consist of clients and servers. Clients initiate requests to servers; servers process requests and return appropriate responses. Requests and responses are built around the transfer of “representations” of “resources”. A resource can be essentially any coherent and meaningful concept that may be addressed. A representation of a resource may be a document that captures the current or intended state of a resource. At any particular time, a client can either be transitioning between application states or at rest. A client in a rest state is able to interact with its user, but creates no load and consumes no per-client storage on the set of servers or on the network. The client may begin to send requests when it is ready to transition to a new state. While one or more requests are outstanding, the client is considered to be transitioning states. The representation of each application state contains links that may be used next time the client chooses to initiate a new state transition.

The third class of the HTTP streaming servers according to this example classification is a dynamic HTTP streaming server. Otherwise similar to the second class, but the HTTP server and the dynamic streaming server form a single component. In addition, a dynamic HTTP streaming server may be state-keeping.

Server-end solutions can realize HTTP streaming in two modes of operation: static HTTP streaming and dynamic HTTP streaming. In the static HTTP streaming case, the content is prepared in advance or independent of the server. The structure of the media data is not modified by the server to suit the clients' needs. A regular web server in “static” mode can only operate in static HTTP streaming mode. In the dynamic HTTP streaming case, the content preparation is done dynamically at the server upon receiving a non-cached request. A regular web server operationally connected with a dynamic streaming server and a dynamic HTTP streaming server can be operated in the dynamic HTTP streaming mode.

### Transport File Format

In an example embodiment transport file formats can be coarsely categorized into two classes. In the first class transmitted files are compliant with an existing file format that can be used for file playback. For example, transmitted files are compliant with the ISO Base Media File Format or the progressive download profile of the 3GPP file format.

In the second class transmitted files are similar to files formatted according to an existing file format used for file playback. For example, transmitted files may be fragments of a server file, which might not be self-containing for playback individually. In another approach, files to be transmitted are compliant with an existing file format that can be used for file playback, but the files are transmitted only partially and hence playback of such files requires awareness and capability of managing partial files.

Transmitted files can usually be converted to comply with an existing file format used for file playback.

### HTTP Cache

An HTTP cache 150 (FIG. 1) may be a regular web cache that stores HTTP requests and responses to the requests to reduce bandwidth usage, server load, and perceived lag. If an HTTP cache contains a particular HTTP request and its response, it may serve the requestor instead of the HTTP streaming server.

### HTTP Streaming Client

An HTTP streaming client 120 receives the file(s) of the media presentation. The HTTP streaming client 120 may contain or may be operationally connected to a media player 130 which parses the files, decodes the included media streams and renders the decoded media streams. The media player 130 may also store the received file(s) for further use. An interchange file format can be used for storage.

In some example embodiments the HTTP streaming clients can be coarsely categorized into at least the following two classes. In the first class conventional progressive downloading clients guess or conclude a suitable buffering time for the digital media files being received and start the media rendering after this buffering time. Conventional progressive downloading clients do not create requests related to bitrate adaptation of the media presentation.

In the second class active HTTP streaming clients monitor the buffering status of the presentation in the HTTP streaming client and may create requests related to bitrate adaptation in order to guarantee rendering of the presentation without interruptions.

The HTTP streaming client 120 may convert the received HTTP response payloads formatted according to the transport file format to one or more files formatted according to an interchange file format. The conversion may happen as the HTTP responses are received, i.e. an HTTP response is written to a media file as soon as it has been received. Alternatively, the conversion may happen when multiple HTTP responses up to all HTTP responses for a streaming session have been received.

### Interchange File Formats

In some example embodiments the interchange file formats can be coarsely categorized into at least the following two classes. In the first class the received files are stored as such according to the transport file format.

In the second class the received files are stored according to an existing file format used for file playback.

### A Media File Player

A media file player 130 may parse, decode, and render stored files. A media file player 130 may be capable of parsing, decoding, and rendering either or both classes of interchange files. A media file player 130 is referred to as a legacy player if it can parse and play files stored according to an existing file format but might not play files stored according to the transport file format. A media file player 130 is referred to as an HTTP streaming aware player if it can parse and play files stored according to the transport file format.

In some implementations, an HTTP streaming client merely receives and stores one or more files but does not play them. In contrast, a media file player parses, decodes, and renders these files while they are being received and stored.

In some implementations, the HTTP streaming client 120 and the media file player 130 are or reside in different devices. In some implementations, the HTTP streaming client 120 transmits a media file formatted according to a interchange file format over a network connection, such as a wireless local area network (WLAN) connection, to the media file player 130, which plays the media file. The media file may be transmitted while it is being created in the process of converting the received HTTP responses to the media file. Alternatively, the media file may be transmitted after it has been completed in the process of converting the received HTTP responses to the media file. The media file player 130 may decode and play the media file while it is being received. For example, the media file player 130 may download the media file progressively using an HTTP GET request from the HTTP streaming client. Alternatively, the media file player 130 may decode and play the media file after it has been completely received.

HTTP pipelining is a technique in which multiple HTTP requests are written out to a single socket without waiting for the corresponding responses. Since it may be possible to fit several HTTP requests in the same transmission packet such as a transmission control protocol (TCP) packet, HTTP pipelining allows fewer transmission packets to be sent over the network, which may reduce the network load.

A connection may be identified by a quadruplet of server IP address, server port number, client IP address, and client port number. Multiple simultaneous TCP connections from the same client to the same server are possible since each client process is assigned a different port number. Thus, even if all TCP connections access the same server process (such as the Web server process at port 80 dedicated for HTTP), they all have a different client socket and represent unique connections. This is what enables several simultaneous requests to the same Web site from the same computer.

### Categorization of Multimedia Formats

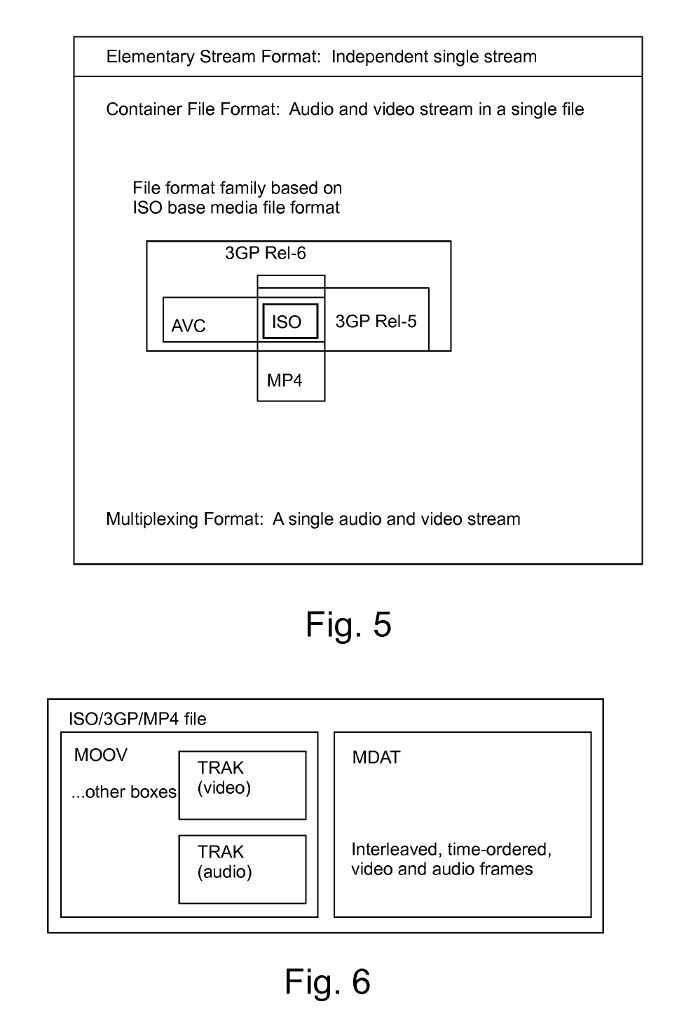

The multimedia container file format is an element used in the chain of multimedia content production, manipulation, transmission and consumption. There may be substantial differences between a coding format (also known as an elementary stream format) and a container file format. The coding format relates to the action of a specific coding algorithm that codes the content information into a bitstream. The container file format comprises means of organizing the generated bitstream in such way that it can be accessed for local decoding and playback, transferred as a file, or streamed, all utilizing a variety of storage and transport architectures. Furthermore, the file format can facilitate interchange and editing of the media as well as recording of received real-time streams to a file. An example of the hierarchy of multimedia file formats is described in FIG. 5.

Some available media file format standards include ISO base media file format (ISO/IEC 14496-12), MPEG-4 file format (ISO/IEC 14496-14, also known as the MP4 format), AVC file format (ISO/IEC 14496-15) and 3GPP file format (3GPP TS 26.244, also known as the 3GP format). The SVC and MVC file formats are specified as amendments to the AVC file format.

The ISO base media file format is the base for derivation of all the above mentioned file formats (excluding the ISO base media file format itself). These file formats (including the ISO base media file format itself) are called the ISO family of file formats.

The basic building block in the ISO base media file format is called a box. Each box has a header and a payload. The box header indicates the type of the box and the size of the box e.g. in terms of bytes. A box may enclose other boxes, and the ISO file format specifies which box types are allowed within a box of a certain type. Furthermore, some boxes are present in each file, while others are optional. Moreover, for some box types, it is allowed to have more than one box present in a file. It could be concluded that the ISO base media file format specifies a hierarchical structure of boxes.

According to ISO family of file formats, a file consists of media data and metadata that are enclosed in separate boxes, the media data (mdat) box and the movie (moov) box, respectively. For a file to be operable, both of these boxes should be present, unless media data is located in one or more external files and referred to using the data reference box as described subsequently. The movie box may contain one or more tracks, and each track resides in one track box. A track can be at least one of the following types: media, hint, timed metadata. A media track refers to samples formatted according to a media compression format (and its encapsulation to the ISO base media file format). A hint track refers to hint samples, containing cookbook instructions for constructing packets for transmission over an indicated communication protocol. The cookbook instructions may contain guidance for packet header construction and include packet payload construction. In the packet payload construction, data residing in other tracks or items may be referenced, i.e. it is indicated by a reference which piece of data in a particular track or item is instructed to be copied into a packet during the packet construction process. A timed metadata track refers to samples describing referred media and/or hint samples. For the presentation one media type, typically one media track is selected.

Samples of a track are implicitly associated with sample numbers that are incremented by 1 in the indicated decoding order of samples. The first sample in a track is associated with sample number 1.

FIG. 6 shows an example of a simplified file structure according to the ISO base media file format.

Although not illustrated in FIG. 6, many files formatted according to the ISO base media file format start with a file type box, also referred to as the ftyp box. The ftyp box contains information of the brands labeling the file. The ftyp box includes one major brand indication and a list of compatible brands. The major brand identifies the most suitable file format specification to be used for parsing the file. The compatible brands indicate which file format specifications and/or conformance points the file conforms to. It is possible that a file is conformant to multiple specifications. All brands indicating compatibility to these specifications should be listed, so that a reader only understanding a subset of the compatible brands can get an indication that the file can be parsed. Compatible brands also give a permission for a file parser of a particular file format specification to process a file containing the same particular file format brand in the ftyp box.

A legacy file player is capable of parsing and playing a file formatted according to a file format, such as ISO base media file format, MPEG-4 file format, and 3GPP file format, but need not be capable of parsing and playing the transport file format, such as the segment format of HTTP streaming. A legacy file player checks and identifies the brands it supports from the ftyp box of a file, and parses and plays the file only if the file format specification supported by the legacy file player is listed among the compatible brands.

It is noted that the ISO base media file format does not limit a presentation to be contained in one file, but it may be contained in several files. One file contains the metadata for the whole presentation. This file may also contain all the media data, whereupon the presentation is self-contained. The other files, if used, are not required to be formatted to ISO base media file format. They are used to contain media data, and may also contain unused media data, or other information. The ISO base media file format concerns the structure of the presentation file only. The format of the media data files is constrained the ISO base media file format or its derivative formats only in that the media data in the media files should be formatted as specified in the ISO base media file format or its derivative formats.

The ability to refer to external files is realized through data references as follows. The sample description box contained in each track includes a list of sample entries, each providing detailed information about the coding type used, and any initialization information needed for that coding. All samples of a chunk and all samples of a track fragment use the same sample entry. A chunk is a contiguous set of samples for one track. The data reference box, also included in each track, contains an indexed list of addresses such as Uniform Resource Locators (URL), resource names such as Uniform Resource Names (URN), and self-references to the file containing the metadata. A sample entry points to one index of the data reference box, hence indicating the file containing the samples of the respective chunk or track fragment.

Movie fragments can be used when recording content to ISO files in order to avoid losing data if a recording application stops its operation, runs out of storage space, or some other incident happens. Without movie fragments, data loss may occur because the file format specifies that all metadata (the movie box) be written in one contiguous area of the file. Furthermore, when recording a file, there may not be sufficient amount of memory (e.g. random access memory, RAM) to buffer a movie box for the size of the storage available, and re-computing the contents of a movie box when the movie is closed may be too slow. Moreover, movie fragments can enable simultaneous recording and playback of a file using a regular ISO file parser. Finally, smaller duration of initial buffering may be required for progressive downloading, i.e. simultaneous reception and playback of a file, when movie fragments are used and the initial movie box is smaller compared to a file with the same media content but structured without movie fragments.

The movie fragment feature enables to split the metadata that conventionally would reside in the movie box to multiple pieces, each corresponding to a certain period of time for a track. In other words, the movie fragment feature enables to interleave file metadata and media data. Consequently, the size of the movie box can be limited and the use cases mentioned above be realized.

The media samples for the movie fragments reside in a box which may be called an mdat box, as usual, if they are in the same file as the movie box. For the meta data of the movie fragments, however, a movie fragment box (a moof box) is provided. It comprises the information for a certain duration of playback time that would previously have been in the movie box. The movie box still may represent a valid movie on its own but in addition it may comprise an mvex box indicating that movie fragments will follow in the same file. The movie fragments extend the presentation that is associated to the movie box in time.

Within the movie fragment there is a set of track fragments, zero or more per track. The track fragments in turn contain zero or more track runs, each of which document a contiguous run of samples for that track. Within these structures, many fields are optional and can be defaulted.

The metadata that can be included in the movie fragment box is limited to a subset of the metadata that can be included in a movie box and may be coded differently in some cases. Details of the boxes that can be included in a movie fragment box can be found from the ISO base media file format specification.

### Adaptive HTTP Streaming

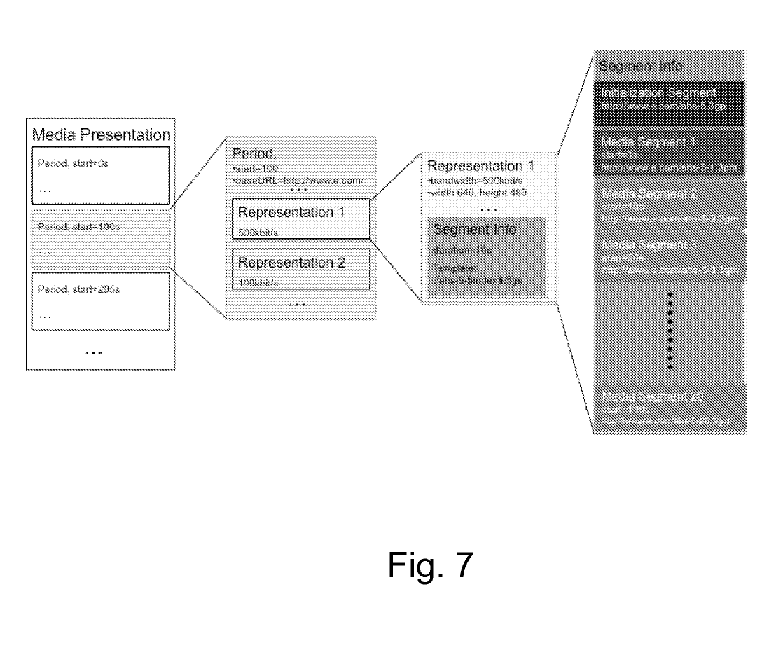

A media presentation is a structured collection of encoded data of a single media content, e.g. a movie or a program. The data is accessible to the HTTP streaming client to provide a streaming service to the user. As shown in FIG. 7, a media presentation consists of a sequence of one or more consecutive non-overlapping periods; each period contains one or more representations from the same media content; each representation consists of one or more segments; and segments contain media data and/or metadata to decode and present the included media content.

Period boundaries permit to change a significant amount of information within a media presentation such as a server location, encoding parameters, or the available variants of the content. The period concept is introduced among others for splicing of a new content, such as advertisements and logical content segmentation. Each period is assigned a start time, relative to start of the media presentation.

Each period itself may consist of one or more representations. A representation is one of the alternative choices of the media content or a subset thereof differing e.g. by the encoding choice, for example by bitrate, resolution, language, codec, etc.

Each representation includes one or more media components where each media component is an encoded version of one individual media type such as audio, video or timed text. Each representation is assigned to a group. Representations in the same group are alternatives to each other. The media content within one period is represented by either one representation from a zero group, or the combination of at most one representation from each non-zero group.

A representation may contain one initialisation segment and one or more media segments. Media components are time-continuous across boundaries of consecutive media segments within one representation. Segments represent a unit that can be uniquely referenced by an http-URL (possibly restricted by a byte range). Thereby, the initialisation segment contains information for accessing the representation, but no media data. Media segments contain media data and they may fulfill some further requirements which may contain one or more of the following examples:

Each media segment is assigned a start time in the media presentation to enable downloading the appropriate segments in regular play-out mode or after seeking. This time is generally not accurate media playback time, but only approximate such that the client can make appropriate decisions on when to download the segment such that it is available in time for play-out.

Media segments may provide random access information, i.e. presence, location and timing of Random Access Points.

A media segment, when considered in conjunction with the information and structure of a media presentation description (MPD), contains sufficient information to time-accurately present each contained media component in the representation without accessing any previous media segment in this representation provided that the media segment contains a random access point (RAP). The time-accuracy enables seamlessly switching representations and jointly presenting multiple representations.

Media segments may also contain information for randomly accessing subsets of the Segment by using partial HTTP GET requests.

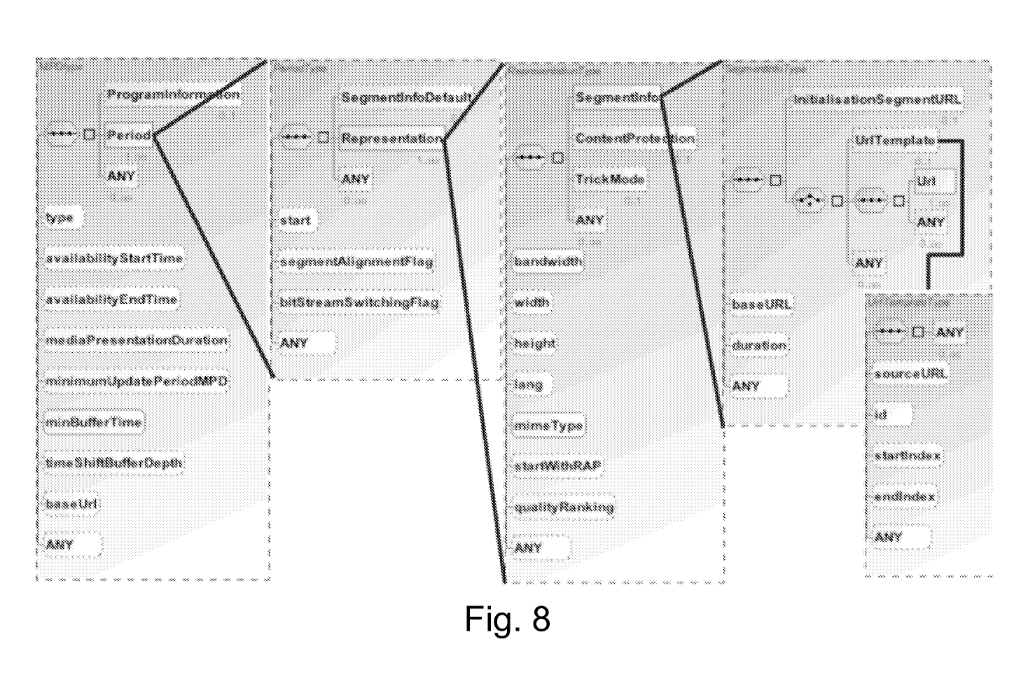

A media Presentation is described in a media presentation description (MPD), and the media presentation description may be updated during the lifetime of a media presentation. In particular, the media presentation description describes accessible segments and their timing. The media presentation description is a well-formatted extensible markup language (XML) document and the 3GPP Adaptive HTTP Streaming specification (3GPP Technical Specification 26.234 Release 9, Clause 12) defines an XML schema to define media presentation descriptions. A media presentation description may be updated in specific ways such that an update is consistent with the previous instance of the media presentation description for any past media. An example of a graphical presentation of the XML schema is provided in FIG. 8. The mapping of the data model to the XML schema is highlighted. The details of the individual attributes and elements may vary in different embodiments.

Adaptive HTTP streaming supports live streaming services. In this case, the generation of segments may happens on-the-fly. Due to this clients may have access to only a subset of the segments, i.e. the current media presentation description describes a time window of accessible segments for this instant-in-time. By providing updates of the media presentation description, the server may describe new segments and/or new periods such that the updated media presentation description is compatible with the previous media presentation description.

Therefore, for live streaming services a media presentation may be described by the initial media presentation description and all media presentation description updates. To ensure synchronization between client and server, the media presentation description provides access information in a coordinated universal time (UTC time). As long as the server and the client are synchronized to the UTC time, the synchronization between server and client is possible by the use of the UTC times in the media presentation description instances.

Time-shift viewing and network personal video recording (PVR) functionality are supported as segments may be accessible on the network over a long period of time.

In the following an example is disclosed on how the received segments can be converted to a file conforming to the ISO Base Media File Format (and the streams included in the file conforming to the respective coding formats).

Conversion from a Transport Format to an Interchange File Format

### Example 1

### No Adaptation, One Period

Segments within only one period, and within only one representation within the only one period were requested by the streaming client, and the representation has its own initialisation segment (IS), i.e. the initialisation segment has a unique URL that is different from the URL of any other initialisation segments. Only one representation means that there is no adaptation (or switching between representations). Only one period means that there is no change of configuration that requires a new initialisation segment or a new ‘moov’ box. In this case, the client may simply record the concatenation of the initialisation segment and the following consecutive media segments, and the concatenation is a valid file, to both legacy and HTTP streaming aware players.

If the representation and other representations share the same initialisation segment (i.e. the value of the InitialisationSegmentURL element is the same for those representations), then the recorded file contains a ‘moov’ box that declares more tracks than contained in the file.

### Example 2

### No Adaptation, Multiple Periods

Segments across more than one period, and within only one representation within each period were requested, and the representation has its own initialisation segment (IS). Again, there is no adaptation within a period, but more than one initialisation segment (i.e. more than one ‘moov’ box) is involved. In this case, the concatenation of the initialisation segments and the media segments, in correct order, would not be a valid file, as there can be only one ‘moov’ box in a syntactically correct file conforming to the ISO base media file format. One way to make the file valid is to combine the second ‘moov’ box to the first one, and correcting the timing at period boundaries when necessary.

When the representations in different periods use the same track_ID for any particular media type, one way to combine multiple ‘moov’ boxes is to use more than one sample entry for each track to document the different configurations. The recorded file is valid to both legacy and HTTP streaming awareplayers.

If different values of track_IDs are used for any particular media type, one alternative is to change some of the track_IDs such that the representations in different periods use the same track_ID for any particular media type; and to merge the ‘moov’ boxes by using multiple sample entries for each track. This way, the recorded file is valid to both legacy and HTTP streaming awareplayers. Alternatively, no changes to the track_IDs are made, but the ‘moov’ boxes are merged by using multiple tracks for one media type. However, in this alternative, edit lists and/or empty time specified by the track fragment structures might be needed to make timing correct for tracks not starting from the first period to make the file valid to both legacy and HTTP streaming aware players, and if editing is not provided, correct timing may be provided by ‘sidx’ or ‘tfdt’ boxes, but then the recorded file may only be valid to new players, and might not be valid to legacy players.

### Example 3

### With Adaptation, One Period

Within one period, switching between representations occurred, and the representation has its own initialisation segment (IS). In this case, the receiver requests the initialisation segment of the switching-to representation before requesting any media segments of the switching-to representation. Thus, the concatenation will include more than one ‘moov’ box. Consequently, merging of the ‘moov’ box, same as discussed above in Example 2, may be needed.

If the representations involved within a period share the same initialisation segment, then requesting of initialisation segment at switching points is not needed, hence there will still be just one ‘moov’ box involved. The following applies.

Adaptive HTTP streaming allows to re-use a track ID value for several representations. For example, it is possible that all video tracks are stored in separate files in the server and use the same track ID. The client can switch between the video representations during the streaming session. The track ID value remains unchanged in the server files and in the segments extracted from the server files. Hence, under certain constraints explained below, the switching between the representations may be seamless, i.e., cause no interruption in the playback.

The media presentation description contains a period-level attribute called bitstreamSwitchingFlag. When the value of the period-level attribute is true, it indicates that the result of the splicing on a bitstream level of any two time-sequential media segments within a period from any two different representations in the same group (hence containing the same media types) can be concatenated into a file conforming to the ISO Base Media File Format.

If the value of the period-level attribute bitstreamSwitchingFlag is ‘true’ for the period, then same value of track_ID is used for any particular media type in all the involved representations, and timing would also be correct when the file is played by a legacy player. That is, the recorded result is a valid file to both legacy and HTTP streaming aware players.

According to the semantics, when the value of the period-level attribute bitstreamSwitchingFlag is true, assuming that ms1 and ms2 are two time-sequential media segments within the period, and ms1 is from a video representation A and ms2 is from a video representation B, then a client can request ms2 substantially immediately after ms1 (i.e. switching from representation A to representation B) and decode ms2 using the initialization data of representation A.

This implies that, if the video codec in use is H.264/AVC, and all sequence and picture parameter sets are included in the initialization data, then the two video representations A and B should use the same set of parameter sets to enable the value of the period-level attribute bitstreamSwitchingFlag to be set to true, as the splicing operation mentioned in the semantics is “on a bitstream level”.

This further implies that, when the value of the period-level attribute bitstreamSwitchingFlag is true, all representations containing video in the period should use the same video codec.

If the value of the period-level attribute bitstreamSwitchingFlag is true, then alternative video representations using different video codecs are not be included in same media presentation.

If the value of the period-level attribute bitstreamSwitchingFlag is true, the concatenation of an Initialization Segment, if present, with all consecutive media segments of a single representation within a period, starting with the first media segment, results in a syntactically valid file and the media data contained in the file constitutes a valid bitstream (according to the specific elementary bitstream format) that is also semantically correct (i.e. if the concatenation is played, the media content within this period is correctly presented). When the value of the period-level attribute flag is set to ‘true’, such consecutive segments following the same constraints may come from any representation within the same group within this period.

Otherwise, i.e. if the value of the period-level attribute bitstreamSwitchingFlag is ‘false’, regardless of whether different values of track_ID are used for any particular media type in all the involved representations, edit lists or empty time indicated by track fragment structures would need to be added to make the file valid to legacy players; if edits or empty time are not provided, correct timing may be provided by ‘sidx’ or ‘tfdt’ boxes, but then the recorded file can only be valid to HTTP streaming aware players, and would not be valid to legacy players.

### Example 4

### With Adaptation, Multiple Periods

The fourth example case is similar as Example 2 (no adaptation, multiple periods), with the only difference being additional ‘moov’ boxes also within one period. From file recording point of view, there is no essential difference between additional ‘moov’ boxes at period starts or within periods, thus possible changes needed to make the recording result a valid file conforming to a file format are almost the same.

### Stream Switching

The segment index box, which may be available at the beginning of a segment, can assist in the switching operation. The segment index box is specified as follows.

The segment index box (‘sidx’) provides a compact index of the movie fragments and other segment index boxes in a segment. Each segment index box documents a subsegment, which is defined as one or more consecutive movie fragments, ending either at the end of the containing segment, or at the beginning of a subsegment documented by another segment index box.

The indexing may refer directly to movie fragments, or to segment indexes which (directly or indirectly) refer to movie fragments; the segment index may be specified in a ‘hierarchical’ or ‘daisy-chain’ or other form by documenting time and byte offset information for other segment index boxes within the same segment or subsegment.

There are two loop structures in the segment index box. The first loop documents the first sample of the subsegment, that is, the sample in the first movie fragment referenced by the second loop. The second loop provides an index of the subsegment.

In media segments not containing a Movie Box (‘moov’) but containing Movie Fragment Boxes (‘moof’), if any segment index boxes are supplied then a segment index box should be placed before any Movie Fragment (‘moof’) box, and the subsegment documented by that first Segment Index box shall be the entire segment.

One track (normally a track in which not every sample is a random access point, such as video) is selected as a reference track. The decoding time of the first sample in the sub-segment of at least the reference track, is supplied. The decoding times in that sub-segment of the first samples of other tracks may also be supplied.

The reference type defines whether the reference is to a Movie Fragment (‘moof’) Box or Segment Index (‘sidx’) Box. The offset gives the distance, in bytes, from the first byte following the enclosing segment index box, to the first byte of the referenced box. (i.e. if the referenced box immediately follows the ‘sidx’, this byte offset value is 0).

The decoding time (for the reference track) of the first referenced box in the second loop is the decoding_time given in the first loop. The decoding times of subsequent entries in the second loop are calculated by adding the durations of the preceding entries to this decoding_time. The duration of a track fragment is the sum of the decoding durations of its samples (the decoding duration of a sample is defined explicitly or by inheritance by the sample_duration field of the track run (‘trun’) box); the duration of a sub-segment is the sum of the durations of the track fragments; the duration of a segment index is the sum of the durations in its second loop. The duration of the first segment index box in a segment is therefore the duration of the entire segment.

A segment index box contains a random access point (RAP) if any entry in their second loop contains a random access point.

The decoding time documented for all tracks by the first segment index box after a movie box ‘moov’ should be 0.

The container for ‘sidx’ box is the file or segment directly. In the following an example of a container for the ‘sidx’ box is illustrated by using a pseudo code:

```
      aligned(8) class SegmentIndexBox extends FullBox(‘sidx’,
      version, 0) {
  a.  unsigned int(32) reference_track_ID;
  b.  unsigned int(16) track_count;
  c.  unsigned int(16) reference_count;
  d.  for (i=1; i<= track_count; i++)
  e.  {
i.unsigned int(32)  track_ID;
  ii.if (version==0)
iii.{
    1.  unsigned int(32)  decoding_time;
iv.} else
  v.{
    1.  unsigned int(64)  decoding_time;
vi.}
    f.}
    g.  for(i=1; i <= reference_count; i++)
    h.  {
    i.bit (1)  reference_type;
  ii.unsigned int(31) reference_offset;
iii.unsigned int(32) subsegment_duration;
iv.bit(1)  contains_RAP;
  v.unsigned int(31) RAP_delta_time;
    i.}
      }
```

In the following the terminology used in the pseudo code will be shortly explained.

reference_track_ID provides the track_ID for the reference track.

track_count: the number of tracks indexed in the following loop; track_count shall be 1 or greater;

reference_count: the number of elements indexed by second loop; reference_count shall be 1 or greater;

track_ID: the ID of a track for which a track fragment is included in the first movie fragment identified by this index; exactly one track_ID in this loop shall be equal to the reference_track_ID;

decoding_time: the decoding time for the first sample in the track identified by track_ID in the movie fragment referenced by the first item in the second loop, expressed in the timescale of the track (as documented in the timescale field of the Media Header Box of the track);

reference_type: when set to 0 indicates that the reference is to a movie fragment (‘moof’) box; when set to 1 indicates that the reference is to a segment index (‘sidx’) box;

reference_offset: the distance in bytes from the first byte following the containing segment index box, to the first byte of the referenced box;

subsegment_duration: when the reference is to segment index box, this field carries the sum of the subsegment_duration fields in the second loop of that box; when the reference is to a movie fragment, this field carries the sum of the sample durations of the samples in the reference track, in the indicated movie fragment and subsequent movie fragments up to either the first movie fragment documented by the next entry in the loop, or the end of the subsegment, whichever is earlier; the duration is expressed in the timescale of the track (as documented in the timescale field of the Media Header Box of the track);

contains_RAP: when the reference is to a movie fragment, then this bit may be 1 if the track fragment within that movie fragment for the track with track_ID equal to reference_track_ID contains at least one random access point, otherwise this bit is set to 0; when the reference is to a segment index, then this bit shall be set to 1 only if any of the references in that segment index have this bit set to 1, and 0 otherwise;

RAP_delta_time: if contains_RAP is 1, provides the presentation (composition) time of a random access point (RAP); reserved with the value 0 if contains_RAP is 0. The time is expressed as the difference between the decoding time of the first sample of the subsegment documented by this entry and the presentation (composition) time of the random access point, in the track with track_ID equal to reference_track_ID.

Stream Switching without Segment Index Box

In the case without Segment Index, seamless switching is possible on a Segment basis, possibly involving download of overlapping Segments.

The purpose of the Segment Alignment flag (in the media presentation description) is to indicate whether Segment Boundaries are aligned in a precise way that simplifies seamless switching. The media presentation description also contains a representation-level attribute called startWithRAP. When the value of the representation-level attribute startWithRAP is true, it indicates that all segments in the representation start with a random access point.

If the Segment Alignment flag is true, there are two cases to consider, with and without the property that every Segment starts with a Random Access Point (indicated by the StartsWithRAP flag in the media presentation description). If StartsWithRAP is false, then the client should follow an approach similar to non-aligned segments and download overlapping data. In this case, the client downloads the respective Segments of both the old and new representations (in order to obtain some overlap in which to search for a RAP). The alignment of segments in time simplifies correct timing recovery. If StartsWithRAP is true, then seamless switching can be achieved without downloading overlapping data: the client simply downloads the next segment from the target representation.

If the Segment Alignment flag is false, it may be necessary for a client that wishes to switch rate to speculatively download a Segment from the new stream that overlaps in time with downloaded Segments of the old stream. The client may then search the new stream data for a Random Access Point within the overlap, which can then be used as the switch point. If no such Random Access Point exists then additional overlapping data should be downloaded until one is found. In order to ensure seamless switching, despite the need to download overlapping data, it is likely necessary that the client operates with stream rates substantially below the available bandwidth.

Stream Switching with Segment Index Box

When the segment index box is present, the client may first identify the Segment of the new stream to which it would like to switch. This is likely the segment containing the earliest composition time (Tend) for which no data has been requested from the old stream.

The client then may consult the Segment Index for that Segment to identify a suitable Random Access Point as switch point. This is ideally the latest RAP that is no later than Tend. The client may then request only the Fragment containing this Random Access Point and subsequent fragments. This minimizes the amount of overlapping data that must be downloaded, whilst avoiding the need for coordinated placement of Random Access Points across representations.

Some embodiments of the invention suit at least one or both of the following two scenarios:

In the first scenario, an HTTP streaming client records the received transport file format segments into an interchange file that complies with ISO base media file format or its derivatives, such as 3GP file format or MP4 file format.

In the second scenario, an HTTP streaming client merely receives and stores one or more files, but does not play them. In contrast, a file player parses, decodes, and renders these files while they are being received and stored.

While the 3GPP segment format is derived from the ISO base media file format, it is non-trivial to compose a file from received segments in many cases, including the following:

In the first case there are multiple initialization segments, which may happen, for example, when consequent periods are recorded, there are multiple independent non-alternative representations (e.g. audio and video in a separate representation), and/or alternative representations have their own initialization segment. A file compliant to ISO base media file format should have exactly one movie box. It may be necessary to consider how should the content of the Movie boxes in each initialization segment be combined into the file being composed.

In the second case, when several non-alternative representations are received simultaneously (e.g. audio and video are in different representations), one issue is to determine how the received segments are combined into a file. For example, how is the value of the sequence_number in movie fragment header box set? Sequence_number in the file should be incremented by 1 per each movie fragment header box in appearance order in the file.

In the third case, if alternative representations use different track_ID values and switching between representations occurs during streaming, some samples in the received tracks are not present. Decoding times of samples are derived from the sample durations that are indicated in the respective track fragment headers. All track fragment headers starting from the beginning of the file have to be present to obtain correct decoding times for samples. Consequently, some sample times are wrong, because not all track fragment headers of all tracks are received.

In the fourth case, if alternative representations use the same track_ID value and switching between representations occurs during streaming, the initialization segment for the track may contain sample entries for any sample in any alternative representation. However, such an initialization segment may indicate a profile and level that are higher than required for those representations that are actually received. When such an initialization segment is used in an interchange file, some players may abandon the file as too demanding for the decoding and playback capabilities of the player device.

In the fifth case, in some presentations provided for streaming, the segments might not start with a random access point (startWithRAP attribute has a value false). When switching between representations (and startWithRAP has a value false), there are at least two possibilities for a client operation. First, the client may request both the segment of the switch-from representation and the time-overlapping representation of the switch-to representation. The switch between the representations may occur at a random access point within the segment of the switch-to representation. It is not obvious how these segments of switch-from and switch-to representations should be stored in an interchange file, particularly if the switch-from and switch-to representation share the same track_ID value. Second, the client may request only the headers of the segments in the switch-from and switch-to representation, and the media data of the segment of the switch-from representation until a switch point, and the media data of the segment of the switch-to representation starting from a switch point. However, the track fragment headers of these segments would also refer to the media samples that are not received and hence be non-compliant.

In the following an example embodiment of the invention for file construction is disclosed in more detail.

In some embodiments there may be three types of file construction instruction sequences. In some other embodiments there may be one, two or more than three types of file construction instruction sequences.

The first type is an initialization file construction instruction sequence (FCIS). The initialization file construction instruction sequence contains instructions for the file type box, the progressive download information box (if any), and the movie box.

The second type is a representation file construction instruction sequence. The representation file construction instruction sequence contains instructions to store segments of a representation as movie fragment boxes and associated media data boxes.

The third type is a switching file construction instruction sequence. The switching file construction instruction sequence contains instructions to reflect a switch from the reception of one representation to another in the file structures.

The initialization file construction instruction sequence may depend on which representations are intended to be received, because a track box is needed for each representation which cannot share the same track identifier value. The initialization file construction instruction sequence may depend on which representations are intended to be received, also because it may be advantageous to include only those sample entries that are referred to in the received media segments into the respective track box included in the file.

In some embodiments, the Initialization FCIS may be over-complete, i.e., it may contain instructions regarding tracks or sample entries that will not be present in the file. The advantage of such over-complete Initialization FCIS is that a single Initialization FCIS is sufficient regardless of the combination of representations that are received or intended to be received.

In some embodiments, a finalization FCIS may be created by the file encapsulator, transmitted from the HTTP streaming server to the HTTP streaming client, and processed by the HTTP streaming client. The finalization FCIS is processed last after all other file construction instruction sequences for the received HTTP responses. The finalization FCIS includes instructions that are intended to finalize the file converted from the received HTTP responses of the streaming session. These instructions may, for example, cause a movie fragment random access box to be created into the file. Alternatively or in addition, these instructions may replace track boxes that are not referred with a free box or overwrite sample description boxes such a way that they only contain sample description entries that are referred by at least one sample, whereas unused sample description entries are removed from the newly written sample description boxes.

The HTTP streaming client may receive initialization segments or self-initializing media segments during a streaming session. This may happen, for example, when a new period is starting or representations are switched and the switch-to representation uses a different initialization segment than the switch-from representation. Initialization segments or self-initializing media segments pose a challenge to the creation of the interchange file, since the moov box typically appears first in the file before mdat box(es) or movie fragments. At least the following approaches may be taken to handle reception of initialization segments or self-initializing media segments during a streaming session when converting the HTTP responses to an interchange file.

First, a moov box can be created after the received media has been written to the file. An initialization FCIS may be executed after all other file construction instruction sequences or a finalization FCIS may contain the instructions to create a moov box. If a finalization FCIS contains the instructions to create a moov box, the initialization FCIS may contain one or more instructions to create a free box into the beginning of the file. The free box is such large that it can be overwritten by a moov box as instructed by the finalization FCIS. In such a manner, the moov box can be made to appear at the beginning of the file, which is more convenient for file players. A disadvantage of writing the moov box after the media data is that the a legacy player cannot parse and play the at the same time as it is being written.

Second, a separate interchange file may be created for each period. These interchange files may be chained in a playlist file or a presentation file, such as a Synchronized Multimedia Integration Language (SMIL) file. When the playlist file or a presentation file is played by a player capable of parsing such files, the periods are played consecutively similarly as an HTTP streaming client plays the respective received HTTP responses.

Third, the HTTP streaming client may attempt to fetch all the initialization segments when the file writing starts even if they would be needed for decoding and playback at a later stage of the streaming session. While the initial buffering delay would increase in such operation, the delay increase is likely to be moderate as the size of the initialization segments is relatively small. However, particularly in live streaming, initialization segments are not necessarily available at the beginning of the streaming session.

Fourth, a re-initialization FCIS may be created by the file encapsulator, transmitted from the HTTP streaming server to the HTTP streaming client, and processed by the HTTP streaming client. For example, when a new period starts, the HTTP streaming client may request a re-initialization FCIS from the HTTP streaming server using an HTTP GET request. A re-initialization FCIS is processed first before any other file construction instructions sequences for the period. A re-initialization FCIS includes instructions that update the moov box created by executing the initialization FCIS and possibly updated by earlier re-initialization file construction initialization sequences. A re-initialization FCIS typically includes instructions for adding tracks and/or sample description entries. It is therefore advantageous if the initialization FCIS causes the creation of free boxes in those locations of the file where additional structures may be created by re-initialization file construction instruction sequences.

In an adaptive HTTP streaming session, multiple representations, such as an audio representation and a video representation, may be received simultaneously. A representation file construction instruction sequence may be multiplexed, such that it includes the instructions for all simultaneously received representations. A multiplexed representation file construction instruction sequence may also include instructions for those representations which may be received during the streaming session but are not currently received. Such instructions may, for example, cause additions of empty samples, empty edits (in an edit list for the respective track), or empty time indicated by track fragment structures.

A representation file construction instruction sequence may also be non-multiplexed or elementary, in which case it includes the instructions of only one representation, while other representations and their representation file construction instruction sequence may also be received simultaneously. A client converting media segments into a file may therefore execute multiple representation file construction instruction sequences in an interleaved manner. Such a client may have to maintain state variables that are common for all representation file construction instruction sequences executed in an interleaved manner, and which the instructions in any representation file construction instruction sequence executed in an interleaved manner may update. An example of such a state variable is the sequence number for movie fragments, which is to be used as the value of the sequence_number syntax element in the movie fragment header box.

A switching file construction instruction sequence contains a number of elements, each containing a sequence of instructions. Each element describes the file creation when a representation is switched to another. Before and after a switching file construction instruction sequence an appropriate representation file construction instruction sequence may be followed. The elements themselves are therefore independent of each other. An element may depend on switch-from representation, switch-to representation, and the exact switch point. An instruction in the switch-from representation switching file construction instruction sequence that is the last one executed and an instruction in the switch-to representation switching file construction instruction sequence that is the first one executed may be indicated in or associated with an element. Elements may but need not be grouped as switching file construction instruction sequences.

Similarly to a representation file construction instruction sequence, a switching file construction instruction sequences may be multiplexed or non-multiplexed. In a multiplexed file construction instruction sequence, the elements also describe the file creation instructions for those representations that are continuously received during a switch. For example, if a multiplexed switching file construction instruction sequence describes the file creation for a switch from one video representation to another, it also includes the instructions for converting the received segments of an audio representation into a file. As the number of required elements for the multiplexed switching file construction instruction sequence may be high, a non-multiplexed switching file construction instruction sequence may be preferred.

The file construction instruction sequence is independent of any particular file format or the media presentation description and can be conveyed through various means. However, particularly when a file construction instruction sequence is included in the initialization segment and media segments, the file construction instruction sequence format should conform to the segment format and hence the ISO base media file format. The conformance to the ISO base media file format may be achieved through specific encapsulation of the file construction instruction sequence. With other types of encapsulation, the same file construction instruction sequence data may be conveyed through other means than the segment format.

One use of the instructions is to instruct a receiver to convert received segments into a file. Consequently, one container format for the instructions is a transport format, similar to that of the segment format for media data. We refer to this container format as the file construction instruction sequence segment format (FCIS segment format). In some embodiments, the initialization file construction instruction sequence may be carried in the initialization segment, and the representation file construction instruction sequence and potentially also the switching file construction instruction sequence may be carried in media segments.

The instructions may also be stored in one or more files accessible by the server, although in some embodiments the instructions may be created on-the-fly i.e. during the download. The one or more files may be independent of the one or more files used to store media data, or file construction instruction sequences may be stored in the same file or files as the media data. In both cases, file construction instruction sequences may use the same basis file format as the media data. For example, the ISO Base Media File Format may be used to store file construction instruction sequences. We refer to the file format for storage of file construction instruction sequences as FCIS file format. In some embodiments, the one or more files containing the file construction instruction sequences are stored in or accessible by a different server from the HTTP streaming server 110, which contains or accesses the media data.

When the instructions are stored in one or more files, each instruction may also be associated with a URL. The URLs may be stored as metadata in the same file(s) as the instructions or in separate one or more files or databases that may be logically linked to the file(s) storing the instructions.

The received file construction instruction sequence segments may be stored in the receiving device (for example the HTTP streaming client 120) e.g. for subsequent conversion of the media segments into a file. The received file construction instruction sequence segments may be converted from the file construction instruction sequence segment format (FCIS segment format) to the FCIS file format.

In some embodiments, one or more files conforming to the FCIS file format are transferred from the server to the client, and FCIS segment format need not be used.

Instructions may have means to refer to a particular set of segments, a particular segment (URL), a particular byte range within a segment, and a particular structure (typically box) within a segment.

At least the following types of instructions may exist:

Instructions can copy data by reference from a referred segment to the file being created.

There may be instructions for replacing data within a copy of a referred segment in the file being created (e.g., rewrite a track ID or sequence_number of a movie fragment).

There may be instructions that are “immediate”, i.e. include text or a byte array to be written to a file.

There may be instructions that maintain state variables associated with the file writing process. For example, a movie fragment sequence number state variable may be associated with the sequence_number of the movie fragment header, and instructions control how and when the movie fragment sequence number state variable is incremented.

The instructions may be formatted similarly to hint tracks of the ISO base media file format or may conform to an XML schema.

If the initialization file construction instruction sequence is provided within the initialization segment or stored in a file conforming to ISO Base Media File Format, it may be included, for example, as a new box in the User Data box (contained in the Movie box), in a new box in the file/segment level or under the Movie box, or as a metadata item and referred from a ‘meta’ box. A URL may be associated to the Initialization FCIS stored in a file. The URL may, for example, be stored in the same new box containing the Initialization FCIS itself.

If the initialization file construction instruction sequence is transferred independently of the initialization segment or self-initializing media segment, it need not be framed by a box structure but it can just contain a sequence of instructions. If the initialization file construction instruction sequence is not transmitted in the initialization segment or self-initializing media segment, the receiver may store it in a file, which may conform to the ISO Base Media File Format and include the initialization file construction instruction sequence as a new box in the User Data box (contained in the Movie box), in a new box in the file/segment level or under the Movie box, or as a metadata item and referred from a ‘meta’ box.

The initialization file construction instruction sequence may depend on which representations are intended to be received, for example because a Track box should be provided for each representation which cannot share the same track identifier value. Instructions on the intention to receive a particular representation or any representation within a particular group of (alternative) representations may therefore be needed in an initialization file construction instruction sequence. Instructions may therefore include selections based on a representation or a group of representations or based on the result of a comparison including combinations of representations or groups of representations combined with logical operations, such as OR, AND, XOR (exclusive OR), and NOT. Alternatively or in addition, a separate initialization file construction instruction sequence may be specified for combinations of representations intended to be received in one streaming session. Such initialization file construction instruction sequence is associated with the representations it covers and those representations may be indicated with the URL of the initialization file construction instruction sequence within the media presentation description. In some embodiments, a conditional XML structure may be used, such as the switch element of the Synchronized Multimedia Integration Language (SMIL) standard by the World Wide Web Consortium (W3C). Alternatively or in addition, a URL template may be specified in the media presentation description, including placeholders for representation identifiers. An initialization file construction instruction sequence obtained with the URL when the placeholders are replaced by representation identifiers covers the representations whose identifiers are used in converting the URL template to the actual URL.

The representation file construction instruction sequence can be partitioned to samples, each of which represents one media segment. Each sample may contain a number of instructions. The representation file construction instruction sequence can therefore be represented as a track of the ISO base media file format. It can be considered a hint track or a timed metadata track. However, decoding time is not necessarily indicated for FCIS samples (as explained in the following paragraph), which differentiates an FCIS track from hint tracks and timed metadata tracks. A new track type (also known as a sample description handler type), such as ‘fcis’, may therefore be specified. When ‘fcis’ handler type is used for a track, the presence of sample time indications may be optional. A track reference (of type ‘fcis’) is included in an FCIS track to refer to the related media track, if the media track is stored in the same file. A sample entry format for an FCIS track may be specified as follows:

class FcisSampleEntry( ) extends SampleEntry (transport_format) {
unsigned int(8) data [ ];
}

Instructions and/or file construction instruction sequence samples need not but can be associated with a time, which may be a relative sending time, which could be used if a push or broadcast protocol instead of the HTTP was used. If an FCIS track is used, the time may be indicated as the sample time (also known as a decoding time), which is indicated through the Decoding Time to Sample box and the Track Fragment Header boxes (if any). When an instruction or an FCIS sample is processed at the indicated time, the media segment required for processing the instruction of the FCIS sample should be available.

While embodiments describing a file construction instruction sequence for HTTP streaming are provided, file construction instruction sequences for other communication protocols and/or other transport file formats could be specified. Each file construction instruction sequence for a different communication protocol and/or transport file format may be dedicated a specific four-character code used as the input parameter transport_format in the FCIS sample entry format introduced above. A specific file construction instruction sequence format may be specified, for example, for a particular Real-time Transport Protocol (RTP) payload specification. Such a file construction instruction sequence enables conversion of a sequence of RTP packets to a file.

If an FCIS track is used, the sample entry for adaptive HTTP streaming may be specified to include the representation IDs of the related representations. If the same file contains multiple representation file construction instruction sequences, the representation ID stored in the sample entry may be used to differentiate between the tracks and find a correct track for a particular representation on the basis of a media presentation description. The sample entry for adaptive HTTP streaming may be formatted as follows:

class FcisDashSampleEntry( ) extends FcisSampleEntry (‘dash’) {
representationListBox representation_list; // optional
}
class representationListBox extends Box (‘rlst’) {
unsigned int(32) representation_id[ ]; // until the end of the box
}

Alternatively or in addition, one or more identifiers for groups of representations could be provided in the sample entry.

As representation file construction instruction sequences may be represented as a track of the ISO Base Media File Format, the representation file construction instruction sequences may be stored in one or more files conforming to the ISO Base Media File Format. A file containing a representation file construction instruction sequence may also contain media tracks intended for adaptive HTTP streaming. Hence, the same file can be a single source for a streaming server to provide both media segments and file construction instruction sequence segments to clients.

Moreover, as representation file construction instruction sequences may be represented as a track of the ISO Base Media File Format, the media segment format of the 3GPP adaptive HTTP streaming can be used as the FCIS segment format. The FCIS segments may have their own URL and be fetched independently of the respective media segment. Alternatively, the media segment format can be used to convey both the media track fragments and the FCIS track fragments and the associated sample data. The client can convert the received segments to one or more files conforming to the ISO Base Media File Format, either file construction instruction sequence(s) in separate file(s) compared to the media data or both file construction instruction sequence(s) and media data in the same file(s).

An example of the sample format for file construction instruction sequences is described later in this description.

In some embodiments, representation FCIS samples may be specified for each movie fragment (and the respective mdat box) rather than for each segment.

A representation FCIS track or individual representation FCIS samples may be associated to a URL template or a URL. The URL template may, for example, be stored in a URL template box within the User Data box of the FCIS track. Alternatively or in addition, the linkage of URLs and FCIS samples may be maintained externally, e.g. in a database including the URLs and the respective identifications of the FCIS samples (e.g., in terms of file name, track ID, and sample number).

Similarly to representation file construction instruction sequence, switching file construction instruction sequence may be represented as a track of the ISO Base Media File Format and the switching file construction instruction sequence(s) may be stored in one or more files conforming to the ISO Base Media File Format. A file containing switching file construction instruction sequence(s) may also contain representation file construction instruction sequence(s) and may also contain media tracks intended for adaptive HTTP streaming. Hence, the same file can be a single source for a streaming server to provide both media segments and FCIS segments to clients.

Switching FCIS tracks are separate from the FCIS track that is being switched from and the FCIS track being switched to. Switching FCIS tracks can be identified by the existence of a specific required track reference in that track, as explained in detail below. A switching FCIS sample is an alternative to the sample in the switch-to representation FCIS track that has exactly the same sample number. If switching is not possible at a particular sample of a switch-to representation FCIS track, an empty sample (a sample with size equal to 0) may be included in the respective switching FCIS track. A sample in the switching FCIS track is processed instead of the respective sample in the switch-to representation FCIS track when switching between representations happened at that sample. If a switching FCIS track is specified for starting the reception of a representation or a group of alternative representations later than the period start time, no further information is needed.

If a switching FCIS track is specified for switching from one representation FCIS track to another, then two extra pieces of information may be needed. First, the switch-from FCIS track should be identified by using a track reference. The switch-from track may be the same track as the switch-to track for cases when it is possible to turn off the reception of a particular group of representations for a while. Second, the dependency of the switching FCIS sample on the samples in the switch-from representation FCIS track may be needed, so that a switching FCIS sample is only used when the necessary earlier samples in the switch-from FCIS track have been processed.

This dependency may be represented by means of an optional extra sample table. There is one entry per sample in the switching track. Each entry records the relative sample number in the switch-from track on which the switching FCIS sample depends, i.e. which should be processed before the switching FCIS sample in order to construct a valid file. If the dependency box is not present, then the switching FCIS track only documents starting the reception of a representation or a group of alternative representations later than the period start time.

The switching FCIS track should be linked to the track into which it switches (the destination or switch-to representation FCIS track) by a track reference of type ‘swto’ in the switching FCIS track. The switching FCIS track should be linked to the track from which it switches (the source or switch-from representation FCIS track) by a track reference of type ‘swfr’ in the switching FCIS track. If the switching FCIS track only documents starting the reception of a representation or a group of alternative representations later than the period start time, the track reference of type ‘swfr’ is not present in the switching FCIS track.

The syntax of the Sample Dependency box is the same as for the same box in the AVC file format but the semantics are adapted to FCIS tracks.

Box Type: ‘sdep’

Container: Sample Table ‘stbl’ or Track Fragment Box (‘traf’) Mandatory: No

Quantity: Zero or exactly one (per container)

This box contains the sample dependencies for each switching sample. The dependencies are stored in the table, one record for each sample. When the Sample Dependency box is contained in the Sample Table box, the size of the table, sample_count, is taken from the sample_count in the Sample Size Box (‘stsz’) or Compact Sample Size Box (‘stz2’). When the Sample Dependency box is contained in the Track Fragment box, the size of the table, sample_count, is taken from the sum of the sample_count fields of the Track Fragment Run boxes contained in the same Track Fragment box.

```
aligned(8) class SampleDependencyBox
a.  extends FullBox(‘sdep’, version = 0, 0) {
b.  for (i=0; i < sample_count; i++){
i.unsigned int(16) dependency_count;
ii.for (k=0; k < dependency_count; k++) {
  1.  signed int(16) relative_sample_number;
iii.}
  c.  }
    }
```

dependency_count is an integer that counts the number of samples in the switch-from track on which this switching sample directly depends, i.e., which must be processed before the switching FCIS sample in order to construct a valid file. For switching FCIS tracks, dependency_count must be 1.

relative_sample_number is an integer that identifies a sample in the source track (also called as a switch-from track). The relative sample numbers are encoded as follows. If there is a sample in the source track with the same sample number, it has a relative sample number of 0. The sample in the source track which immediately precedes the sample number of the switching sample has relative sample number −1, the sample before that −2, and so on. Similarly, the sample in the source track which immediately follows the sample number of the switching sample has relative sample number +1, the sample after that +2, and so on.

Similarly to representation file construction instruction sequence, a switching FCIS track or individual Switching FCIS samples may be associated to a URL template or a URL. The URL template may, for example, be stored in a Switching URL template box within the User Data box of the FCIS track. Alternatively or in addition, the linkage of URLs and FCIS samples may be maintained externally, e.g., in a database including the URLs and the respective identifications of the FCIS samples (e.g., in terms of file name, track ID, and sample number).

The media segment format of the 3GPP adaptive HTTP streaming can be used as the switching FCIS segment format. The switching FCIS segments may have their own URL and be fetched independently of the respective media segments and the respective representation FCIS segments. The segment and fragment boundaries of the switching FCIS are identical to those of the switch-to representation and the number of samples in both switch-to representation FCIS and the switching FCIS is also the same. Hence, sample number need not be recovered from the beginning of the movie or stream, but it is sufficient to recover the correspondence of the samples in switch-to representation FCIS and switching FCIS from the beginning of the segment or appropriate fragment.

The Sample Dependency box need not be included in switching FCIS segments. The HTTP streaming client may have other means, such as the Segment Index box, to determine which segment and movie fragment in the switch-from representation corresponds to the switching FCIS segment and switch-to representation FCIS segment. If the Sample Dependency box is anyway included in switching FCIS segments, it may be required that the segment and fragment boundaries of the switch-from representation FCIS are identical to those of the switching FCIS and the number of samples in both switch-from representation FCIS and the switching FCIS is also the same. Consequently, the sample number need not be recovered from the beginning of the movie or stream, but it is sufficient to recover the correspondence of the samples in switch-from representation FCIS and switching FCIS from the beginning of the segment or appropriate fragment.

Alternatively, the media segment format can be used to convey the media track fragments, the representation FCIS track fragments, the switching FCIS track fragments, and the associated sample data. Since such media segments would be associated with a single URL regardless of whether a switch of representations have occurred or which representation was the switch-from representation before the switch, such media segments contain track fragments from all the switching FCIS tracks whose switch-to representation corresponds to the media tracks conveyed in the media segments.

The client can convert the received segments to one or more files conforming to the ISO Base Media File Format, either FCIS in separate file(s) compared to the media data or both FCIS and media data in the same file(s).

Associating a first sample with a second sample in another track may be achieved through decoding time correspondence in the ISO Base Media File Format structures. For example, a sample in a timed metadata track is associated to the sample in the referred media or hint track having the same decoding time. Furthermore, the Extractor Network Abstraction Layer (NAL) unit structure specified in the AVC file format causes data copying from a sample in another track that has the closest decoding time to the sample containing the Extractor NAL unit (with a possibility to specify a sample count offset for the sample matching). Similarly, the Sample Dependency box in the AVC file format uses decoding time matching. One advantage of specifying the sample correspondence in terms of decoding time is that it is fairly robust in file editing operations, where samples may be added or removed. In one embodiment of the invention, sample times are used for the FCIS tracks, i.e. the Decoding Time to Sample box is present and sample_duration is used to derive sample times in track fragments. A switching FCIS sample is an alternative to the sample in the switch-to representation FCIS track that has exactly the same decoding time. Furthermore, the correspondence for the Sample Dependency box is initialized in decoding time, i.e. relative_sample_number equal to 0 is specified as follows: a sample in the source track with the closest decoding time to the decoding time of the switching sample, it has a relative sample number of 0. If there are two samples having a decoding time equally close to the decoding time of the switching sample, then the earlier one of these two samples has relative_sample_number equal to 0.

In some embodiments, there are more than one potential switching points within a Segment. A separate Switching FCIS sample may be created for each switching point and associated with a URL. Consequently, the URL template for Switching FCIS may include a placeholder identifier for a switching point index. Alternatively, a single Switching FCIS sample may be created for a Segment, but the Switching FCIS sample contains constructors that are conditionally executed based on the used switch point.

In some embodiments, Switching FCIS samples may be specified for each Movie Fragment of the switch-to representation rather than each Segment. In some embodiments, a switching FCIS sample may be specified for each switching point rather than for each segment or each movie fragment.

In some embodiments, an FCIS sample may be specified as follows. The same structure for an FCIS sample may be applied for initialization FCIS, representation FCIS, and switching FCIS.

aligned(8) class FCISSample {
a. ConstructorBox[ ]; // zero or more constructor boxes
}

A sample in an FCIS track reconstructs file structures that contain the media data of one segment and the associated file metadata. The sample contains zero or more constructors, which are executed sequentially when parsing the sample.

In some embodiments, a representation FCIS sample and a switching FCIS sample may be specified as follows.

```
  aligned(8) class FCISSample {
  a.  do {
i.ConstructorGroup constructors_for_fragment;
  b.  } // while not end of the sample
    }
```

A sample in an FCIS track reconstructs file structures that contain the media data of one segment and the associated file metadata. The constructors_for_fragment syntax element contains a group of constructors. Each such group of constructors provides the instruction sequence for converting a movie fragment and the respective mdat box to data in a file being constructed. The number of such group of constructors corresponds to the number of movie fragments within the respective segment. The syntax and semantics for the ConstructorGroup constructor are provided below.

In some embodiments, a switching FCIS sample may be specified as follows.

```
  aligned(8) class SwitchingFCISSample {
  a.  do {
  i.unsigned int(32) switchpoint_count;
ii.ConstructorGroup constructors_for_sp[switchpoint_count];
  b.  } // while not end of the sample
  }
```

A switching FCIS sample as specified above contains switching instructions for a particular pair of switch-from and switch-to representations and a particular segment of a switch-to representation. Each loop entry corresponds to a movie fragment in the switch-to segment. Each movie fragment of the switch-to segment may have zero or more switch points, the count of which is indicated by the switchpoint_count syntax element. For each switch point, a group of constructors may be included in the constructors_for_sp[i] syntax element, where i is the index of the switch point within the movie fragment.

### FCIS Constructors

In the following some examples of file construction instruction sequences are illustrated as a pseudo code.

aligned(8) class URLConstructor extends Box(‘urlc’) {
a. string url;
b. unsigned int(32) byte_offset; // optional
c. unsigned int(32) byte_count; // present if byte_offset is present.
}

url is a null-terminated string of UTF-8 characters. If byte_offset and byte_count are not present, the constructor is resolved into the data pointed by the url. If byte_offset and byte_count are present, the constructor is resolved into the block of bytes within the data pointed to by the url, starting from the byte offset byte_offset and covering byte_count number of contiguous bytes. byte_offset equal to 0 refers to the first byte of the data pointed to by the url.

aligned(8) class URLTemplate1Constructor extends Box(‘ut1c’) {
a. unsigned int(32) representation_id;
b. unsigned int(32) byte_offset; // optional
c. unsigned int(32) byte_count; // present if byte_offset is present.
}

The constructor may be resolved by forming a referred URL first. If this constructor is used, the sourceUrlTemplatePeriod attribute in the SegmentInfoDefault element of the media presentation description shall be present. The sourceUrlTemplatePeriod attribute contains both the $RepresentationID$ identifier and the $Index$ identifier. A sub-string “$<Identifier>$” names a substitution placeholder matching a mapping key of “<Identifier>”. In the request URL, the substitution placeholder $RepresentationID$ is replaced by representation_id. In one alternative embodiment, representation_id is not present in the constructor, and the substitution placeholder $RepresentationID$ is replaced by the representation ID associated with the present FCIS track. The substitution placeholder $Index$ is replaced by the sample number of the present sample.

URLs within the media presentation description may be relative or absolute as defined in IETF RFC 3986. Relative URLs at each level of the media presentation description are resolved with respect to the baseURL attribute specified at that level of the document or the document “base URI” as defined in RFC3986 Section 5.1 in the case of the baseURL attribute at the media presentation description level.

If byte_offset and byte_count are not present, the constructor may be resolved into the data pointed by the referred URL. If byte_offset and byte_count are present, the constructor is resolved into the block of bytes within the data pointed to by the referred URL, starting from the byte offset byte_offset and covering byte_count number of contiguous bytes. byte_offset equal to 0 refers to the first byte of the data pointed to by the referred URL.

aligned(8) class URLTemplate2Constructor extends Box(‘ut2c’) {
a. // for segment_index
b. unsigned int(32) byte_offset; // optional
c. unsigned int(32) byte_count; // present if byte_offset is present.
}

The constructor may be resolved by forming a referred URL first. If this constructor is used, the sourceUrl attribute in the UrlTemplate element of the media presentation description shall be present. The sourceUrl attribute contains the $Index$ identifier. A sub-string “$<Identifier>$” names a substitution placeholder matching a mapping key of “<Identifier>”. In the request URL, the substitution placeholder $Index$ is replaced by the sample number of the present sample.

URLs within the media presentation description may be relative or absolute as defined in RFC 3986. Relative URLs at each level of the media presentation description are resolved with respect to the baseURL attribute specified at that level of the document or the document “base URI” as defined in RFC3986 Section 5.1 in the case of the baseURL attribute at the media presentation description level.

If byte_offset and byte_count are not present, the constructor is resolved into the data pointed by the referred URL. If byte_offset and byte_count are present, the constructor is resolved into the block of bytes within the data pointed to by the referred URL, starting from the byte offset byte_offset and covering byte_count number of contiguous bytes. byte_offset equal to 0 refers to the first byte of the data pointed to by the referred URL.

aligned(8) class LongURLConstructor extends Box(‘lurc’) {
a. string url;
b. unsigned int(64) byte_offset;
c. unsigned int(64) byte_count;
}

url is a null-terminated string of UTF-8 characters. The constructor is resolved into the block of bytes within the data pointed to by the url, starting from the byte offset byte_offset and covering byte_count number of contiguous bytes. byte_offset equal to 0 refers to the first byte of the data pointed to by the url.

aligned(8) class ImmediateConstructor extends Box(‘immc’) {
a. byte immediate_data[ ]; // byte array until the end of the box
}

The constructor above is resolved into the block of bytes given in immediate_data.

aligned(8) class ImmediateRunConstructor extends Box(‘imrc’) {
a. unsigned int(32) count;
b. byte immediate_data[ ];
}

The constructor above is resolved by a number of repeated byte arrays, each given in immediate_data and the number of repetitions given in count.

aligned(8) class MovieFragmentConstructor extends Box(‘mfrc’) {
a. ConstructorBox[ ]; // at least one constructor box
}

The constructor above encloses all constructors that describe a movie fragment box. The constructor itself is resolved to no bytes in the file.

A parser maintains a state variable MovieFragmentSequenceNumber, which may be initialized to zero or one at the beginning of the movie. When the header of the MovieFragmentConstructor box is parsed, the parser increments MovieFragmentSequenceNumber by 1. Alternatively, when all the constructors of the Movie Fragment Constructor have been executed, the parser increments MovieFragmentSequenceNumber by 1.

aligned(8) class MovieFragmentConstructorSeqNum extends
Box(‘mfsn’) {
}

The constructor above is resolved into a 32-bit unsigned integer containing the value of MovieFragmentSequenceNumber.

aligned(8) class ConstructorGroup extends Box(‘cngr’) {
a. ConstructorBox[ ]; // at least two constructor boxes
}

The constructor above groups other constructors. It can be used in structures where the syntax only allows a single constructor, but a sequence of constructors should be executed.

```
    aligned(8) class representationSelectionConstructor extends
    Box(‘selc’) {
    a. unsigned int(16) switch_count;
    b. for (i = 0; i < switch_count; i++) {
  i.unsigned int(16) representation_count;
  ii.for (j = 0; j < representation_count; j++)
    1. unsigned int(32) representation_id;
iii.ConstructorBox;
    c. }
    }
```

This constructor enables conditional execution of included constructors based on a set of representation identifiers. When the constructor is included in an initialization FCIS, the constructor is resolved by executing the Constructor Box, when all representation_id values of the loop entry are intended to be received. When the constructor is included in a switching FCIS, the constructor is resolved by executing the Constructor Box, when the identifier of the switch-from and switch-to representation are indicated in the loop entry in the respective order (i.e., the representation identifier of the switch-from is the first in the loop entry).

aligned(8) class fseek extends Box(‘fsek’) {
a. int(32) offset;
b. int(32) origin;
}

The constructor sets the file position for the next write operation to the file according to the values of offset and origin. The constructor may be used, for example, to overwrite free boxes within the moov box with other boxes. The offset syntax element indicates the number of bytes relative to the origin to set a new file position. The following values for the origin syntax element may be specified, while the remaining values may be reserved. Origin equal to 0 indicates the start of the file. Origin equal to −1 indicates the current position in the file. Origin equal to −2 indicates the end of the file.

aligned(8) class insert extends Box(‘isrt’) {
a. ContructorBox[ ]; // at least one constructor box
}

If the file pointer is in another position than the end of the file, the bytes existing in the file may be overwritten when a constructor is executed. This constructor inserts the data created by the contained constructors into the file. In other words, it moves the bytes at and subsequent to the current position ahead when the contained constructors cause data to be written into the file. The constructor may be used, for example, in a re-initialization FCIS when new tracks or sample entries are inserted into the moov box already written to a file.

Other constructors may also be specified. Particularly, logical operations (and, or, exclusive or, not) may be specified within constructors or with constructor structures. Furthermore, loop operations may be specified within constructors.

### Examples of Methods to Obtain FCIS by a Client

In an example embodiment the client 120 requests an initialization FCIS from the server 110. The URL of the initialization FCIS can be given in the media presentation description as exemplified below (see the initializationFcisUrl attribute). If the initialization segment is common for all representations of a period, then the initialization FCIS may be included in the initialization segment and need not be requested separately. The presented example of initialization FCIS URL in the media presentation description assumes that the initialization FCIS is shared among all representations. In some embodiments, the media presentation description may include several initialization FCIS URLs, each for a different set of representations and/or representation groups which may be received by a client.

The client may get the representation FCIS through two alternative mechanisms: First, the representation FCIS may be received as a timed metadata track along with media. In other words, the representation FCIS may be included in the segments of the respective representation. Second, the representation FCIS may be associated with separate URLs (per segment) which can be fetched if the client converts the received media segments into a file. The URLs may be specified through a URL template similar to that for the media segments. An example of the URL template mechanism in the media presentation description is provided below. The element fcisSourceUrlTemplatePeriod, if present, provides a URL template including both $RepresentationID$ identifier and the $Index$ identifier, which are then replaced by appropriate representation ID and segment index to obtain a URL. The element fcisSourceURLTemplate, if present, provides a URL template for the representation that includes the attribute itself. The template includes the $Index$ identifier, which is replaced by the segment index to obtain a URL. The URLs may also be specified through listing the URLs per each segment and representation, possibly including a byte range within the URL.

Similarly to the representation FCIS, the client may get the switching FCIS through two alternative mechanisms: First, the switching FCIS may be received as a timed metadata track along with media. In other words, the switching FCIS may be included in the segments of the respective representation. Typically, a media segment of the switch-to representation would include a set of switching FCISs, one for each potential switch-from representation and possibly one for the case where no representation of the same group was received earlier. Second, the switching FCIS may be associated with separate URLs (per segment) which can be fetched if the client converts the received media segments into a file. As the switching FCIS depends on both switch-from representation and the switch-to representation, the URL template for switching FCIS (switchingFcisSourceUrlTemplatePeriod in the example below) includes $SwitchFromRepresentationID$, $SwitchToRepresentationID$, and $Index$ identifiers. These are replaced by the IDs of the switch-from and switch-to representations and the segment index of the switch-to representation where the switching appeared. In another, alternative template mechanism, realized through the switchingFcisSourceURLTemplate element in the media presentation description below, a number of URL templates is provided in the media presentation description, each for a different pair of switch-from and switch-to representation. The switchingFcisSourceURLTemplate attribute includes the $Index$ identifier, which is replaced by an appropriate segment index (of the switch-to representation) in order to obtain a URL. The URLs of the switching FCIS may also be specified through listing the URLs per each segment, switch-from representation, and switch-to representation, possibly including a byte range within the URL.

An example of the media presentation description modifications for FCIS URL indications is provided below. The media presentation description of 3GPP TS 26.234 version 9.3.0 is appended below with FCIS URLs and URL templates, indicated by underlining.

| | Type | | | |
|---|---|---|---|---|
| | (Attribute | | | |
| | or | | | |
| Element or Attribute Name | Element) | Cardinality | Optionality | Description |
| MPD | E | 1 | M | The root element that carries the |
| | | | | Media Presentation Description for |
| | | | | a Media Presentation. |
| type | A | | OD | “OnDemand” or “Live”. |
| | | | default: | Indicates the type of the Media |
| | | | OnDemand | Presentation. Currently, on- |
| | | | | demand and live types are defined. |
| | | | | If not present, the type of the |
| | | | | presentation shall be inferred as |
| | | | | OnDemand. |
| availabilityStartTime | A | | CM | Gives the availability time (in UTC |
| | | | Must be | format) of the start of the first |
| | | | present | period of the Media Presentation. |
| | | | for | |
| | | | type = “Live” | |
| availabilityEndTime | A | | O | Gives the availability end time (in |
| | | | | UTC format). After this time, the |
| | | | | Media Presentation described in |
| | | | | this MPD is no longer accessible. |
| | | | | When not present, the value is |
| | | | | unknown. |
| mediaPresentationDuration | A | | O | Specifies the duration of the entire |
| | | | | Media Presentation. If the attribute |
| | | | | is not present, the duration of the |
| | | | | Media Presentation is unknown. |
| minimumUpdatePeriodMPD | A | | O | Provides the minimum period the |
| | | | | MPD is updated on the server. If |
| | | | | not present the minimum update |
| | | | | period is unknown. |
| minBufferTime | A | | M | Provides the minimum amount of |
| | | | | initially buffered media that is |
| | | | | needed to ensure smooth playout |
| | | | | provided that each representation is |
| | | | | delivered at or above the value of |
| | | | | its bandwidth attribute. |
| timeShiftBufferDepth | A | | O | Indicates the duration of the time |
| | | | | shifting buffer that is available for |
| | | | | a live presentation. When not |
| | | | | present, the value is unknown. If |
| | | | | present for on-demand services, |
| | | | | this attribute shall be ignored by |
| | | | | the client. |
| baseURL | A | | O | Base URL on MPD level |
| ProgramInformation | E | 0, 1 | O | Provides descriptive information |
| | | | | about the program |
| moreInformationURL | A | | O | This attribute contains an absolute |
| | | | | URL which provides more |
| | | | | information about the Media |
| | | | | Presentation |
| Title | E | 0, 1 | O | May be used to provide a title for |
| | | | | the Media Presentation |
| Source | E | 0, 1 | O | May be used to provide |
| | | | | information about the original |
| | | | | source (for example content |
| | | | | provider) of the Media |
| | | | | Presentation. |
| Copyright | E | 0, 1 | O | May be used to provide a copyright |
| | | | | statement for the Media |
| | | | | Presentation. |
| Period | E | 1 . . . N | M | Provides the information of a |
| | | | | period |
| start | A | | M | Provides the accurate start time of |
| | | | | the period relative to the value of |
| | | | | the attribute availabilityStart time |
| | | | | of the Media Presentation. |
| segmentAlignmentFlag | A | | O | When True, indicates that all start |
| | | | Default: | and end times of media |
| | | | false | components of any particular |
| | | | | media type are temporally aligned |
| | | | | in all Segments across all |
| | | | | representations in this period. |
| bitstreamSwitchingFlag | A | | O | When True, indicates that the |
| | | | Default: | result of the splicing on a bitstream |
| | | | false | level of any two time-sequential |
| | | | | media segments within a period |
| | | | | from any two different |
| | | | | representations containing the |
| | | | | same media types complies to the |
| | | | | media segment format. |
| initializationFcisUrl | A | 0, 1 | O | Provides the URL for the |
| | | | | initialization file construction |
| | | | | instruction sequence |
| SegmentInfoDefault | E | 0, 1 | O | Provides default Segment |
| | | | | information about Segment |
| | | | | durations and, optionally, URL |
| | | | | construction. |
| duration | A | | O | Default duration of media |
| | | | | segments |
| baseURL | A | | O | Base URL on period level |
| sourceUrlTemplatePeriod | A | | O | The source string providing the |
| | | | | URL template on period level. |
| fcisSourceUrlTemplatePeriod | A | | O | The source string providing the file |
| | | | | construction instruction sequence |
| | | | | URL template on period level. |
| switchingFcisSourceUrlTemplatePeriod | A | | O | The source string providing the |
| | | | | switching FCIS URL template on |
| | | | | period level. |
| Representation | E | 1 . . . N | M | This element contains a description |
| | | | | of a representation. |
| bandwidth | A | | M | The minimum bandwidth of a |
| | | | | hypothetical constant bitrate |
| | | | | channel in bits per second (bps) |
| | | | | over which the representation can |
| | | | | be delivered such that a client, after |
| | | | | buffering for exactly |
| | | | | minBufferTime can be assured of |
| | | | | having enough data for continuous |
| | | | | playout. |
| width | A | | O | Specifies the horizontal resolution |
| | | | | of the video media type in an |
| | | | | alternative representation, counted |
| | | | | in pixels. |
| height | A | | O | Specifies the vertical resolution of |
| | | | | the video media type in an |
| | | | | alternative representation, counted |
| | | | | in pixels. |
| lang | A | | O | Declares the language code(s) for |
| | | | | this representation according to |
| | | | | RFC 5646 [106]. |
| | | | | Note, multiple language codes may |
| | | | | be declared when e.g. the audio |
| | | | | and the sub-title are of different |
| | | | | languages. |
| mimeType | A | | M | Gives the MIME type of the |
| | | | | initialisation segment, if present; if |
| | | | | the initialisation segment is not |
| | | | | present it provides the MIME type |
| | | | | of the first media segment. |
| | | | | Where applicable, this MIME type |
| | | | | includes the codec parameters for |
| | | | | all media types. The codec |
| | | | | parameters also include the profile |
| | | | | and level information where |
| | | | | applicable. |
| | | | | For 3GP files, the MIME type is |
| | | | | provided according to RFC 4281 |
| | | | | [107]. |
| group | A | | OD | Specifies the group to which this |
| | | | Default: 0 | representation is assigned. |
| startWithRAP | A | | OD | When True, indicates that all |
| | | | Default: | Segments in the representation |
| | | | False | start with a random access point |
| qualityRanking | A | | O | Provides a quality ranking of the |
| | | | | representation relative to other |
| | | | | representations in the period. |
| | | | | Lower values represent higher |
| | | | | quality content. If not present then |
| | | | | the ranking is undefined. |
| ContentProtection | E | 0, 1 | O | This element provides information |
| | | | | about the use of content protection |
| | | | | for the segments of this |
| | | | | representation. |
| | | | | When not present the content is not |
| | | | | encrypted or DRM protected. |
| SchemeInformation | E | 0, 1 | O | This element gives the information |
| | | | | about the used content protection |
| | | | | scheme. The element can be |
| | | | | extended to provide more scheme |
| | | | | specific information. |
| schemeIdUri | A | | O | Provides an absolute URL to |
| | | | | identify the scheme. The definition |
| | | | | of this element is specific to the |
| | | | | scheme employed for content |
| | | | | protection. |
| TrickMode | E | 0, 1 | O | Provides the information for trick |
| | | | | mode. It also indicates that the |
| | | | | representation may be used as a |
| | | | | trick mode representation. |
| alternatePlayoutRate | A | | O | Specifies the maximum playout |
| | | | | rate as a multiple of the regular |
| | | | | playout rate, which this |
| | | | | representation supports with the |
| | | | | same decoder profile and level |
| | | | | requirements as the normal playout |
| | | | | rate. |
| SegmentInfo | E | 1 | | Provides Segment access |
| | | | | information. |
| duration | A | | CM | If present, gives the constant |
| | | | Must be | approximate segment duration. The |
| | | | present | attribute must be present in case |
| | | | in case | duration is not present on period |
| | | | duration | level and the representation |
| | | | is not | contains more than one media |
| | | | present | segment. If the representation |
| | | | on | contains more only one media |
| | | | period | segment, then this attribute may |
| | | | level and | not be present. |
| | | | the | All Segments within this |
| | | | representation | SegmentInfo element have the |
| | | | contains | same duration unless it is the last |
| | | | more | Segment within the period, which |
| | | | than one | could be significantly shorter. |
| | | | media | |
| | | | segment. | |
| baseURL | A | | O | Base URL on representation level |
| InitialisationSegmentURL | E | 0, 1 | O | This element references the |
| | | | | initialisation segment. If not |
| | | | | present each media segment is self- |
| | | | | contained. |
| sourceURL | A | | M | The source string providing the |
| | | | | URL |
| range | A | | O | The byte range restricting the |
| | | | | above URL. If not present, the |
| | | | | resources referenced in the |
| | | | | sourceURL are unrestricted. The |
| | | | | format of the string shall comply |
| | | | | with the format as specified in |
| | | | | section 12.2.4.1. |
| UrlTemplate | E | 0, 1 | CM | The presence of this element |
| | | | Must be | specifies that a template |
| | | | present | construction process for media |
| | | | if the | segments is applied. The element |
| | | | Url | includes attributes to generate a |
| | | | element | Segment list for the representation |
| | | | is not | associated with this element. |
| | | | present. | |
| sourceURL | A | | O | The source string providing the |
| | | | | template. |
| | | | | This attribute and the id attribute |
| | | | | are mutually exclusive. |
| id | A | | CM | An attribute containing a unique |
| | | | Must be | ID for this specific representation |
| | | | present | within the period. |
| | | | if the | This attribute and the sourceURL |
| | | | sourceUrl | attribute are mutually exclusive. |
| | | | Template | |
| | | | Period | |
| | | | attribute | |
| | | | is | |
| | | | present | |
| startIndex | A | | OD | The index of the first accessible |
| | | | default: 1 | media segment in this |
| | | | | representation. In case of on- |
| | | | | demand services or in case the first |
| | | | | media segment of the |
| | | | | representation is accessible, then |
| | | | | this value shall not be present or |
| | | | | shall be set to 1. |
| endIndex | A | | O | The index of the last accessible |
| | | | | media segment in this |
| | | | | representation. If not present the |
| | | | | endIndex is unknown. |
| Url | E | 0 . . . N | CM | Provides a set of explicit URL(s) |
| | | | Must be | for Segments. |
| | | | present | Note: The URL element may |
| | | | if the | contain a byte range. |
| | | | UrlTemplate | |
| | | | element | |
| | | | is not | |
| | | | present. | |
| sourceURL | A | | M | The source string providing the |
| | | | | URL |
| range | A | | O | The byte range restricting the |
| | | | | above URL. If not present, the |
| | | | | resources referenced in the |
| | | | | sourceURL are unrestricted. The |
| | | | | format of the string shall comply |
| | | | | with the format as specified in |
| | | | | section 12.2.4.1 |
| FcisUrlTemplate | E | 0, 1 | O | The element includes attributes to |
| | | | | generate a Segment list for the |
| | | | | FCIS of the representation |
| | | | | associated with this element. This |
| | | | | element and the |
| | | | | fcisSourceUrlTemplatePeriod |
| | | | | attribute are mutually exclusive. |
| fcisSourceURLTemplate | A | | M | The source string providing the |
| | | | | template. |
| SwitchingFcisUrlTemplate | E | 0 . . . N | O | The element includes attributes to |
| | | | | generate a Segment list for the |
| | | | | FCIS of the representation |
| | | | | associated with this element. This |
| | | | | element and the |
| | | | | switchingFcisSourceUrlTemplatePeriod |
| | | | | attribute are mutually |
| | | | | exclusive. |
| switchingFcisSourceURLTemplate | A | 1 | M | The source string providing the |
| | | | | template. |
| switchFromRepresentationId | A | 1 | M | The representation ID of the |
| | | | | switch-from representation |
| | | | | associated with the respective |
| | | | | switchingFcisSourceURLTemplate |

### Client Operations

According to some example embodiments the client 120 may operate as follows:

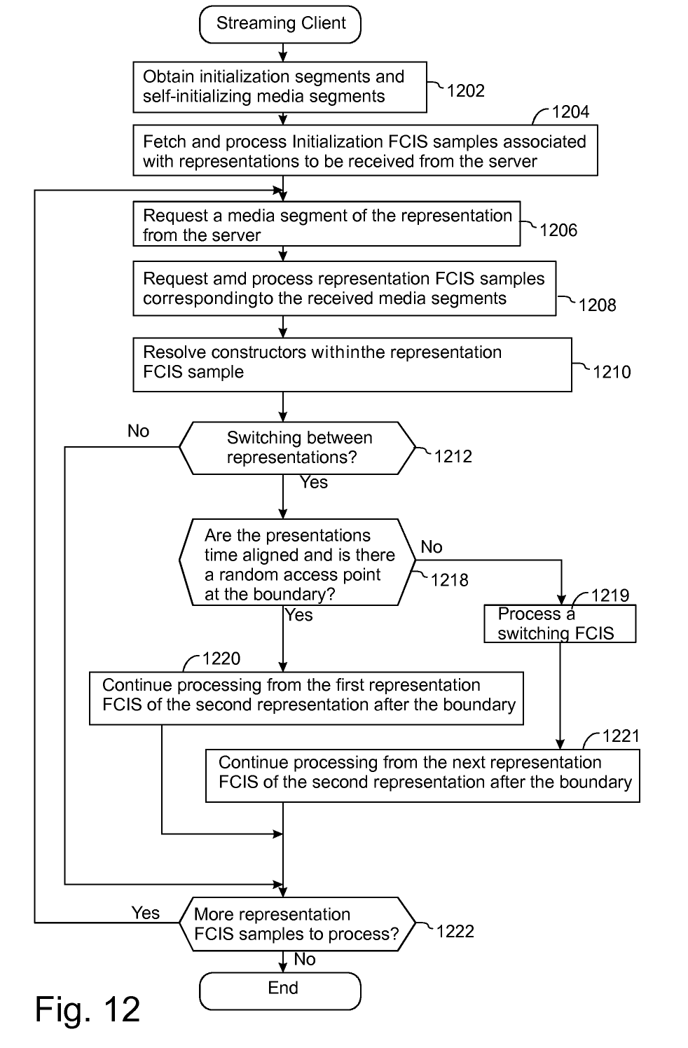

The Initialization Segments (if any) and Self-Initializing media segments (if any) of the received representations are obtained (block 1202 in FIG. 12). The Initialization Segment or the Self-Initializing media segment of a representation may be received before any media segments of the same representation but need not be received before media segments of other representations, if the decoding of the representation starts later e.g. due to representation switching.

The Initialization FCIS samples associated with the representations that are received or that are intended to be received is fetched and processed (block 1204). The Initialization FCIS samples are processed sequentially by resolving the constructors included in each sample sequentially.

The client requests media segments from the desired representations in sequential manner (block 1206). In some embodiments, the client requests movie fragments within a each media segment in sequential manner rather than requesting an entire segment in one HTTP GET request. The client may use the sidx box(es) located in the segment to determine the byte ranges within a segment that contain an integer number of movie fragments and the respective mdat boxes. For example, the client may request a byte range that covers data from one sidx box (inclusive) to the next sidx box (exclusive).

Representation FCIS samples that correspond to the received media segments and/or movie fragments are requested and processed sequentially (block 1208). The constructors within the FCIS samples are resolved sequentially (block 1210, 1222). If multiple non-alternative representations are fetched simultaneously, a client converting segments to a file follows all corresponding representation FCIS tracks. The processing order of any sample in one FCIS track relative to any sample in another FCIS track is not constrained. However, the parser should process one sample at a time and complete the processing of the sample before starting the processing of another sample in any FCIS track. In other words, the processing of one FCIS sample should not be intervened by the processing of any other FCIS sample. In some embodiments, if the sample format is structured according to movie fragments contained in the segment, the parser should process the group of constructors for one movie fragment at a time before starting the processing of another group of constructors for another movie fragment in any FCIS track. In other words, the processing of one constructor for one movie fragment should not be intervened by the processing of any constructors for another movie fragment.

Based on the buffer occupancy, the client analyzes if the throughput of the network is sufficient for maintaining real-time pauseless playback with the current streamed bitrate, or if a lower bitrate would be needed for pauseless playback, or if a higher bitrate could be used for higher quality while still maintaining pauseless playback (block 1212). The client may switch from one representation to another within the same group. Switching may be done on Segment or Movie Fragment boundaries. If random access points are not aligned with Segment or Movie Fragment boundaries, the client may have to request time-overlapping data from two representations. The last representation FCIS sample processed from the switch-from representation FCIS is selected such a manner that it does not contain instructions concerning the switch point.

When switching between representations at a Segment boundary, and Segments of the switch-from and switch-to representations are time-aligned, and the switch-to representation has a random access point at the Segment boundary (block 1218), no switching FCIS has to be processed and the representation FCIS samples of the switch-to representation are processed after the switch (block 1220). Otherwise, the Switching FCIS sample corresponding to the Segment where the switch appeared (and concerning the correct switch-from and switch-to representations) is fetched and processed (block 1219). The representation FCIS sample of the switch-from representation which concerns the Segment containing the switch point is not processed, but the preceding sample is the last representation FCIS sample processed from the switch-from representation. Similarly, the representation FCIS sample of the switch-to representation which concerns the Segment contains the switch point is not processed, but processing of the representation FCIS samples of the switch-to representation continues from the next representation FCIS sample (block 1221).

In some embodiments, when switching between representations at a movie fragment boundary, and movie fragments of the switch-from and switch-to representations are time-aligned, and the switch-to representation has a random access point at the movie fragment boundary, the constructors from the representation FCIS samples of the switch-from representation are processed before the switch, no switching FCIS sample is processed, and the constructors from the representation FCIS samples of the switch-to representation are processed after the switch (block 1220). Otherwise, those constructors from the Switching FCIS sample that correspond to the Movie Fragment where the switch appeared (and concerning the correct switch-from and switch-to representations) are fetched and processed (block 1219). The constructors of the representation FCIS sample of the switch-from representation concerning and subsequent to the movie fragment containing the switch point are not processed, but the immediately preceding constructor is the last one processed from the switch-from representation. Similarly, the constructors of the representation FCIS sample of the switch-to representation which concerns the movie fragment containing the switch point are not processed, but processing of the constructors of the representation FCIS samples of the switch-to representation continues from the immediately subsequent constructor of the representation FCIS sample (block 1221). When the sample format is such that the constructors are grouped according to the movie fragments or when the sample format is such that a sample corresponds to a movie fragment rather than a segment, the identification of which constructors correspond to a particular movie fragment is straightforward.

If the reception of a representation starts later than the reception of other representations, such as in the case of switching subtitles in the middle of the streaming session, a switching FCIS sample is requested and processed for such late starting position.

In some implementations, the client parses, decodes, and renders the received media segments. In other embodiments, the client converts the received segments into a file according to an interchange file format and lets a file player 130 parse, decode, and render the interchange file.

In some embodiments, the data contained in the media segments may be protected and/or encrypted. The client 120 may access the required rights and decryption keys and decrypt the data within the media segments prior to decoding and rendering and/or writing the media data to an interchange file. Alternatively, the client may write the media segments in encrypted or protected format into an interchange file and the media player may access the required rights and decryption access in order to decrypt the media data prior to decoding and rendering.

### File Encapsulator Operations

According to some example embodiments a creator of file construction instruction sequences (e.g. the file encapsulator 100 of FIG. 1) may operate as follows.

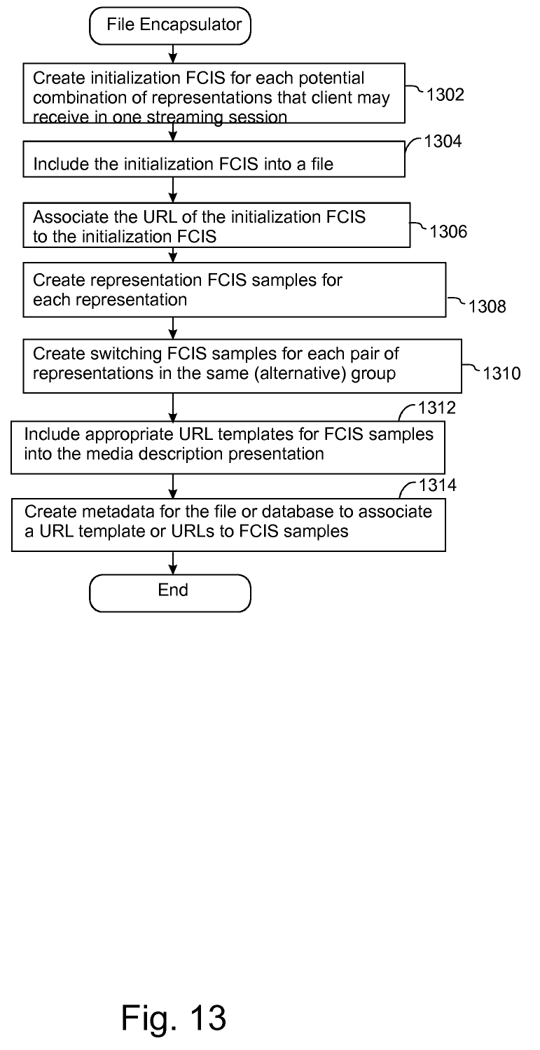

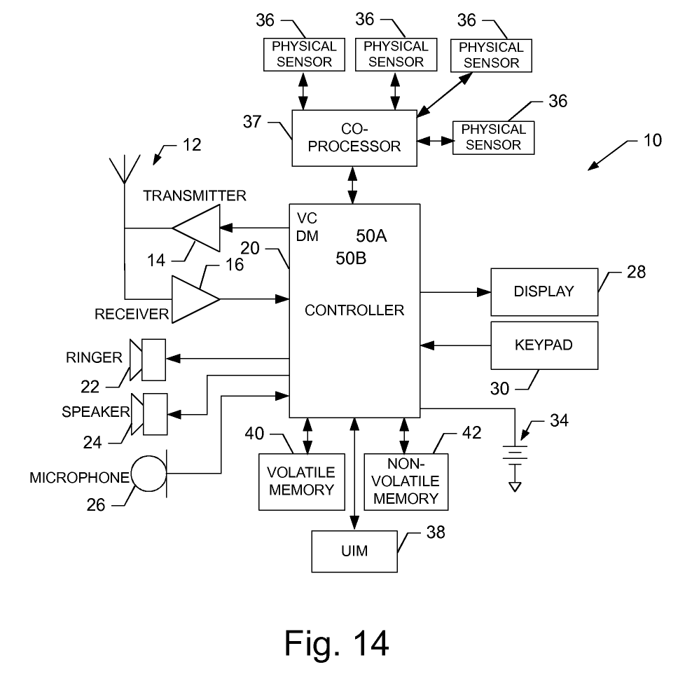

The creator 100 creates an Initialization FCIS for each potential combination of representations that the client may receive in one streaming session (block 1302 in FIG. 13). The Initialization FCIS for some combinations of representations may be identical and hence shared.

In some embodiments, the Initialization FCIS may be over-complete, i.e., it may contain instructions regarding tracks or sample entries that will not be present in the file. The advantage of such over-complete Initialization FCIS is that a single Initialization FCIS is sufficient regardless of the combination of representations that are received or intended to be received. A client 120 may handle an over-complete Initialization FCIS at least in two ways. First, the client 120 may follow the Initialization FCIS literally and create the Movie Header structures for tracks whose samples won't be present in the file. Second, the client 120 may adapt the Initialization FCIS by excluding the Track Box for those tracks whose samples won't be present in the file or those sample entries that won't be referenced by any sample.

The creator 100 may include the Initialization FCIS in a file (block 1304), which may but need not contain the media data too.

The creator 100 may include the URL of the Initialization FCIS into the file containing the Initialization FCIS or the URL may be associated to the Initialization FCIS by other means, such as by maintaining a database of URLs and respective Initialization File Construction Instruction Sequences (block 1306).

The creator 100 may also create representation FCIS samples for each representation (block 1308).

The creator 100 may further create Switching FCIS samples for each pair of representations in the same (alternative) group (block 1310). If it is allowed to start the reception of a representation later than the reception of other representations, such as switching on subtitles in the middle of the streaming session, the creator also creates Switching FCIS samples for such late starting position.

A creator of Media Presentation Description (MPD) operates by including the appropriate URL templates for FCIS samples into the media presentation description (block 1312).

A creator may also create metadata for the file or a database to associate a URL template or URLs to FCIS samples (block 1314).

In some embodiments, the creator 100 creates such instructions that cause more than one file to be constructed for a single streaming session. For example, the instructions may be such that the movie box and movie fragment boxes are written to one file, whereas the media data are written to a second file. Furthermore, the instructions may be such that the data reference box is created to associate the second file to the respective tracks represented by structures in the movie box and movie fragment boxes. An HTTP streaming client may follow such instructions that cause more than one file to be constructed and hence create these files as determined by the file construction instruction sequences. In another example, the creator 100 creates such instructions that each period is written to a separate file.

In the following, an example of FCIS samples is provided for a media presentation description providing one audio representation and two video representations. The Segments of the video representations are time-aligned but do not necessarily contain a random access point at the beginning of each Segment. The video representations are coded with the same codec and share the same track ID. However, as their coding profiles and/or levels differ, they use a different sample description entry. The Initialization Segment for the video representations is shared and includes the sample description entries used in both representations.

The example is written in pseudo-code, where ‘{’ indicates the start of a container structure, such as a box or a constructor, and ‘}’ denotes the end of a container structure.

### Initialization Segment and Initialization FCIS

First, an example of an Initialization Segment for video representations (is1) is illustrated:

```
ftyp {..}
moov {
  mvhd {..}
  trak {..} // video track, track ID #1
}
mvex {
  trex {..}
}
```

Initialization Segment for audio representation (is2) can be implemented as follows:

```
ftyp {..}
moov {
  mvhd {..}
  trak {..} // audio track, track ID #2
}
mvex {
  trex {..}
}
```

Initialization FCIS can be implemented as follows:

```
urlc (
  url = is1;
  byte_offset = 0; // beginning of ftyp
  byte_count = sizeof(ftyp); // assuming that the audio track requires no
additions to brands
}
immc {
  immediate_data // byte array containing moov box header with correct
size that results in subsequent constructors concerning the contents of
the moov box
}
urlc {
  url = is1;
  byte_offset = beginning of mvhd box;
  byte_count = sizeof(mvhd) + sizeof(trak); // assuming that the same
movie header is valid for both video and audio
}
urlc {
  url = is2;
  byte_offset = beginning of trak box;
  byte_count = sizeof(trak);
}
immc {
  immediate_data // byte array containing mvex box header with correct
size that results in subsequent constructors concerning the contents of
the mvex box
}
urlc {
  url = is1;
  byte_offset = beginning of trex box;
  byte_count = sizeof(trex);
}
urlc {
  url = is2;
  byte_offset = beginning of trex box;
  byte_count = sizeof(trex);
}
```

### Media Segments and Representation FCIS

The media segments may have the following structure:

```
sidx {..} // optional
moof {
  mfhd {..}
  traf {
  tfhd {..}
  trun {..} // zero or more trun boxes
  }
}
mdat {..}
```

The corresponding representation FCIS sample may have the following structure:

```
// the sidx box could also be written to a file but it is optional and hence
the respective constructor is omitted here
mfrc {
  immc {
  immediate_data; // byte array containing moof box header and mfhd
box header but not its contents
  }
  mfsn { }
  ut1c { // assuming a corresponding template scheme is used for media
  segments
  representation_id = the representation ID corresponding to the FCIS;
  byte_offset = beginning of traf;
  byte_count = sizeof(traf) + sizeof(mdat);
}
```

If the media segment contains multiple consequent self-containing movie fragments (pairs of moof box followed by an mdat box), each of these would be handled by adding a mfrc constructor similar to the one above in the constructor.

### Switching FCIS

The corresponding Switching FCIS sample may have the following structure:

```
// self-containing movie fragment for switch-from representation
// contains samples until the switch point, exclusive
mfrc {
  immc {
  immediate_data; // byte array containing moof box
header and mfhd box header but not its contents
  }
  mfsn { }
  immc {
  immediate_data; // byte array containing traf box header, tfhd box, trun
box header, sample_count, data_offset (if any), and first_sample_flags
(if any) fields of the trun box.
  }
  ut1c { // assuming a corresponding template scheme is used for media
  segments
  representation_id = switch-from representation ID;
  byte_offset = beginning of sample-specific table within the trun box;
  byte_count = covers samples until the switch point, exclusive;
  }
  immc {
  immediate_data; // byte array containing moov box header
  }
  ut1c { // assuming a corresponding template scheme is used for media
  segments
  representation_id = switch-from representation ID;
  byte_offset = beginning of mdat box payload;
  byte_count = covers samples until the switch point, exclusive;
  }
}
// self-containing movie fragment for switch-to representation
// contains samples starting from the switch point
mfrc {
  immc {
  immediate_data; // byte array containing moof box header and mfhd
box header but not its contents
  }
  mfsn { }
  immc {
  immediate_data; // byte array containing traf box header, tfhd box, trun
box header, sample_count, data_offset (if any), and first_sample_flags
(if any) fields of the trun box.
  }
  ut1c { // assuming a corresponding template scheme is used for media
  segments
  representation_id = switch-to representation ID;
  byte_offset = switch-to sample of the sample-specific table within the
  trun box;
  byte_count = covers samples from the switch point until the end of the
  trun box
  }
  immc {
  immediate_data; // byte array containing moov box header
  }
  ut1c { // assuming a corresponding template scheme is used for media
  segments
  representation_id = switch-to representation ID;
  byte_offset = beginning of the switch-to sample;
  byte_count = covers samples from the switch point until the end of the
track fragment box;
  }
}
```

The above disclosed examples and embodiments were only illustrative and they should not be interpreted as limiting the scope of the invention.

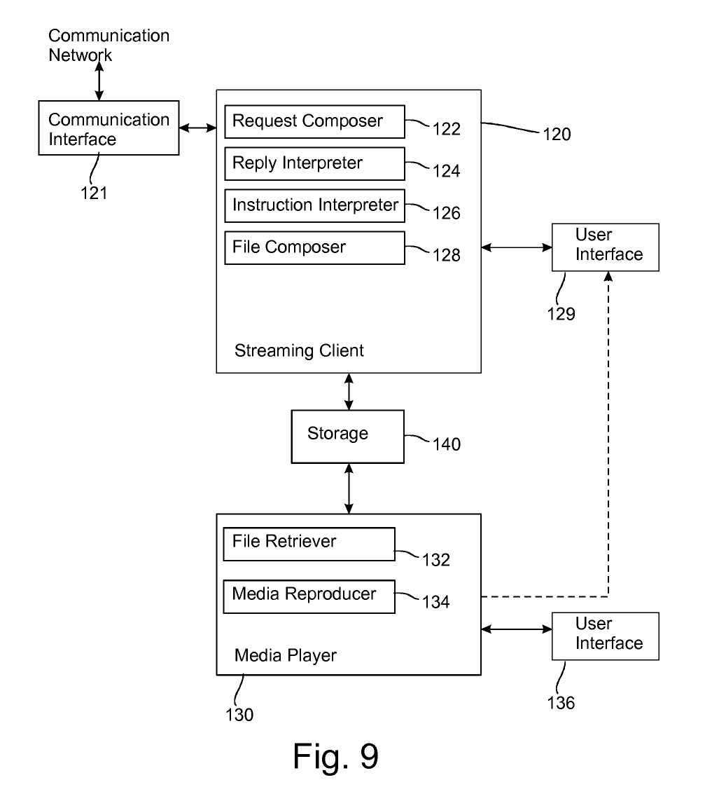

FIG. 9 depicts an example of an apparatus which may be used as the streaming client 120. In this example embodiment the apparatus comprises a request composer 122 which prepares the requests, e.g. GET and other messages to obtain a selected media stream. The communication interface 121 may be used to communicate the requests to the streaming server 110. The communication interface may comprise a transmitter and a receiver and/or other elements for the communication. There may also be a reply interpreter 124 which interprets the replies received from the streaming server. The instruction interpreter 126 is intended to interpret the instructions received from the streaming server 110 which instructions relate to the creation of the files of a format used for file playback from files of a media presentation. The file(s) (segments) of a media presentation and file(s) containing the instructions may be transferred to the streaming client encapsulated in HTTP responses. In some embodiments instructions may be included in the files of the media presentation. The file composer 128 constructs one or more files from the media presentation files on the basis of the instructions. The constructed files in an interchange file format may be stored to the storage 140 and/or transferred to the media player 130 for parsing and playback of the media presentation. The apparatus may also contain a user interface 129 for user input and/or for providing output for the user.

The example of the apparatus of FIG. 9 also contains the media player 130 but as mentioned earlier in this application, the media player 130 may also be a separate device. This example embodiment of the media player contains a file retriever 132 for retrieving files from the storage 140, a media reproducer (parser) 134 for parsing media presentations for playback and for playing the media presentations.

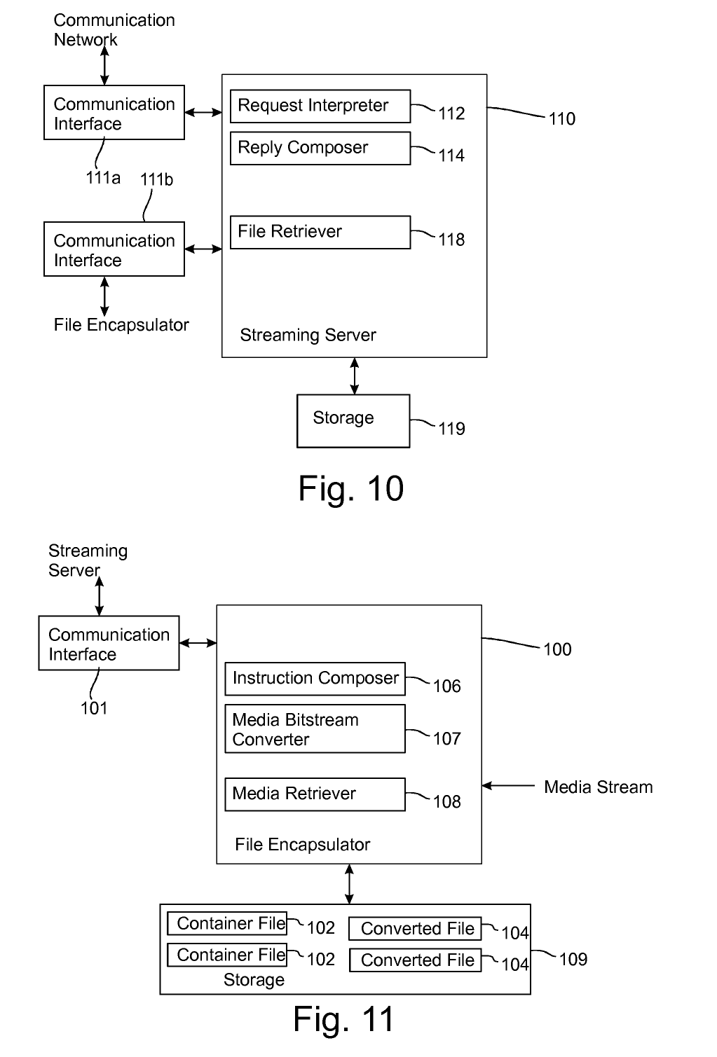

FIG. 10 depicts an example of an apparatus which may be used as the streaming server 110. In this example embodiment the apparatus comprises a request interpreter 112 for interpreting requests received from the streaming client, a reply composer 114 for preparing replies to the requests, and a file retriever 118 for retrieving the media presentation files from e.g. the storage 119 of from other entity, possibly via a network. in this example embodiment the apparatus also comprises a first communication interface 111a for communicating with a communication network e.g. the internet, and a second communication interface 111b for communicating with the file encapsulator 100 (creator). However, it should be noted here that the first and the second communication interface 111a, 111b need not be separate communication interfaces but they may also be constructed as one communication interface. The communication interfaces 111a, 111b comprise a transmitter and a receiver and/or other communication means.

FIG. 11 depicts an example of an apparatus which may be used as the file encapsulator 100. In this example embodiment the apparatus comprises a media retriever 108 which finds and retrieves files (e.g. the converted files 104) of the requested media presentation from a storage 109. The apparatus 100 also comprises an instruction composer 106 for forming instructions which can be used by the streaming client 120 when it prepares the files containing media presentation in an interchange file format. A media bitstream converter 107 converts the media presentation into a bitstream for transmission to the streaming server 110. The apparatus 100 may communicate with the streaming server 110 via a communication interface 101 which may comprise a transmitter and a receiver and/or other communication means. In some embodiments the file encapsulator 100 is part of the streaming server 110 wherein the communication interface 101 may not be needed.

FIG. 15, one example embodiment, illustrates a block diagram of a mobile terminal 10 that would benefit from various embodiments. The mobile terminal 10 could operate as the client device or include the operations of the HTTP streaming client 120. It should be understood, however, that the mobile terminal 10 as illustrated and hereinafter described is merely illustrative of one type of device that may benefit from various embodiments and, therefore, should not be taken to limit the scope of embodiments. As such, numerous types of mobile terminals, such as portable digital assistants (PDAs), mobile telephones, pagers, mobile televisions, gaming devices, laptop computers, cameras, video recorders, audio/video players, radios, positioning devices (for example, global positioning system (GPS) devices), or any combination of the aforementioned, and other types of voice and text communications systems, may readily employ various embodiments. Moreover, it should be understood that also other kinds of terminals which include suitable circuitry may also be capable to provide the operations of the HTTP streaming client 120.

The mobile terminal 10 may include an antenna 12 (or multiple antennas) in operable communication with a transmitter 14 and a receiver 16. The mobile terminal 10 may further include an apparatus, such as a controller 20 or other processing device, which provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN, with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In addition, the mobile terminal 10 may include one or more physical sensors 36. The physical sensors 36 may be devices capable of sensing or determining specific physical parameters descriptive of the current context of the mobile terminal 10. For example, in some cases, the physical sensors 36 may include respective different sending devices for determining mobile terminal environmental-related parameters such as speed, acceleration, heading, orientation, inertial position relative to a starting point, proximity to other devices or objects, lighting conditions and/or the like.

In an example embodiment, the mobile terminal 10 may further include a coprocessor 37. The co-processor 37 may be configured to work with the controller 20 to handle certain processing tasks for the mobile terminal 10. In an example embodiment, the co-processor 37 may be specifically tasked with handling (or assisting with) context model adaptation capabilities for the mobile terminal 10 in order to, for example, interface with or otherwise control the physical sensors 36 and/or to manage the context model adaptation.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), and the like. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10. For example, the memories may include an identifier, such as an international mobile equipment identification (IMEI) code, capable of uniquely identifying the mobile terminal 10.

In some embodiments, the controller 20 may include circuitry desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of an apparatus, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi core processor architecture, as non limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated. Although specific terms are employed herein, they are used in a generic and descriptive sense only and not for purposes of limitation.

A method according to a first embodiment for generating at least one file comprising media data comprises:

receiving a first segment and a second segment,

receiving a first instruction and a second instruction,

modifying the first segment and the second segment on the basis of the first instruction and the second instruction,

creating the at least one file on the basis of the modified first segment and the modified second segment.

In some example embodiments the method comprises receiving media data in said first segment and said second segment.

In some example embodiments said first segment and second segment are received in a transport format.

In some example embodiments said transport format is the hypertext transfer protocol.

In some example embodiments the method comprises using an interchange file format in said generating at least one file.

In some example embodiments said interchange file format belongs to a base media file format of the international organization for standardization.

In some example embodiments said instructions belong to a file construction instruction sequence.

In some example embodiments said file construction instruction sequence comprises at least one of the following:

an initialization file construction instruction sequence;

a representation file construction instruction sequence;

a switching file construction instruction sequence;

a finalization file construction instruction sequence;

a re-initialization file construction instruction sequence.

In some example embodiments said file construction instruction sequences are received in segments, wherein said initialization file construction instruction sequence is received in an initialization segment, and said representation file construction instruction sequence and said switching file construction instruction sequence are received in one or more media segment.

In some example embodiments said file construction instruction sequence comprise at least one of the following:

an initialization file construction instruction sequence;

a representation file construction instruction sequence;

a switching file construction instruction sequence.

In some example embodiments the method comprises using said initialization file construction instruction sequence to contain instructions for a file type box, a progressive download information box, and a movie box.

In some example embodiments the method comprises using said representation file construction instruction sequence to contain instructions to store segments of a representation as movie fragment boxes and associated media data boxes.

In some example embodiments the method comprises using said switching file construction instruction sequence to contain instructions to reflect a switch from the reception of one representation to another in file structures.

An apparatus according to a second embodiment comprises:

a first input configured for receiving a first segment and a second segment;

a second input configured for receiving a first instruction and a second instruction;

a modifier configured for modifying the first segment and the second segment on the basis of the first instruction and the second instruction; and

a file creator configured for creating at least one file on the basis of the modified first segment and the modified second segment.

In some example embodiments the apparatus is configured to receive media data in said first segment and said second segment.

In some example embodiments said first segment and second segment are received in a transport format.

In some example embodiments said transport format is the hypertext transfer protocol.

In some example embodiments the apparatus is configured for using an interchange file format in said generating at least one file.

In some example embodiments said interchange file format belongs to a base media file format of the international organization for standardization.

In some example embodiments said instructions belong to a file construction instruction sequence.

In some example embodiments said file construction instruction sequence comprises at least one of the following:

an initialization file construction instruction sequence;

a representation file construction instruction sequence;

a switching file construction instruction sequence;

a finalization file construction instruction sequence;

a re-initialization file construction instruction sequence.

In some example embodiments the apparatus is configured for receiving said file construction instruction sequences in segments, wherein said initialization file construction instruction sequence is received in an initialization segment, and said representation file construction instruction sequence and said switching file construction instruction sequence are received in one or more media segment.

In some example embodiments said file construction instruction sequence comprise at least one of the following:

an initialization file construction instruction sequence;

a representation file construction instruction sequence;

a switching file construction instruction sequence.

In some example embodiments the apparatus is configured for using said initialization file construction instruction sequence to contain instructions for a file type box, a progressive download information box, and a movie box.

In some example embodiments the apparatus is configured for using said representation file construction instruction sequence to contain instructions to store segments of a representation as movie fragment boxes and associated media data boxes.

In some example embodiments the apparatus is configured for using said switching file construction instruction sequence to contain instructions to reflect a switch from the reception of one representation to another in file structures.

According to a third embodiment there is provided a computer readable storage medium stored with code thereon for use by an apparatus, which when executed by a processor, causes an apparatus to generate at least one file comprising media data, wherein the computer readable storage medium further comprises computer code to cause the apparatus to:

receive a first segment and a second segment,

receive a first instruction and a second instruction,

modify the first segment and the second segment on the basis of the first instruction and the second instruction,

create the at least one file on the basis of the modified first segment and the modified second segment.

In some example embodiments the computer readable storage medium comprises computer code to cause the apparatus to include media data in said first segment and said second segment.

In some example embodiments the computer readable storage medium comprises computer code to cause the apparatus to receive said first segment and second segment in a transport format.

In some example embodiments said transport format is the hypertext transfer protocol.

In some example embodiments the computer readable storage medium comprises computer code to cause the apparatus to use an interchange file format in said generating at least one file.

In some example embodiments said interchange file format belongs to a base media file format of the international organization for standardization.

In some example embodiments said instructions belong to a file construction instruction sequence.

In some example embodiments said file construction instruction sequence comprises at least one of the following:

an initialization file construction instruction sequence;

a representation file construction instruction sequence;

a switching file construction instruction sequence;

a finalization file construction instruction sequence;

a re-initialization file construction instruction sequence.

In some example embodiments the computer readable storage medium further comprises computer code to cause the apparatus to receive said file construction instruction sequences in segments, wherein said initialization file construction instruction sequence is received in an initialization segment, and said representation file construction instruction sequence and said switching file construction instruction sequence are received in one or more media segment.

In some example embodiments said file construction instruction sequence comprises at least one of the following:

an initialization file construction instruction sequence;

a representation file construction instruction sequence;

a switching file construction instruction sequence.

In some example embodiments the computer readable storage medium further comprises computer code to cause the apparatus to use said initialization file construction instruction sequence to contain instructions for a file type box, a progressive download information box, and a movie box.

In some example embodiments the computer readable storage medium further comprises computer code to cause the apparatus to use said representation file construction instruction sequence to contain instructions to store segments of a representation as movie fragment boxes and associated media data boxes.

In some example embodiments the computer readable storage medium further comprises computer code to cause the apparatus to use said switching file construction instruction sequence to contain instructions to reflect a switch from the reception of one representation to another in file structures.

According to a fourth embodiment there is provided at least one processor and at least one memory, said at least one memory stored with code thereon, which when executed by said at least one processor, causes an apparatus to perform:

receiving a first segment and a second segment,

receiving a first instruction and a second instruction,

modifying the first segment and the second segment on the basis of the first instruction and the second instruction,

creating the at least one file on the basis of the modified first segment and the modified second segment.

According to a fifth embodiment there is provided a method for generating a first instruction and a second instruction, wherein

a first segment and a second segment are recognized,

the first instruction and the second instruction are created to indicate at least one modification of the first segment and the second segment such that at least one file can be created on the basis of the modified first segment and the modified second segment.

In some example embodiments the method comprises including media data in said first segment and said second segment.

In some example embodiments said first segment and said second segment are transmitted from a server to a client in a transport format.

In some example embodiments said transport format is the hypertext transfer protocol.

In some example embodiments the method comprises creating instructions that cause more than one file to be constructed for a single streaming session.

In some example embodiments said first and second instruction belong to a file construction instruction sequence.

In some example embodiments said file construction instruction sequence comprises at least one of the following:

an initialization file construction instruction sequence;

a representation file construction instruction sequence;

a switching file construction instruction sequence;

a finalization file construction instruction sequence;

a re-initialization file construction instruction sequence.

In some example embodiments said file construction instruction sequences are included in segments, wherein said initialization file construction instruction sequence is included in an initialization segment, and said representation file construction instruction sequence and said switching file construction instruction sequence are included in one or more media segments.

In some example embodiments said file construction instruction sequence comprise at least one of the following:

an initialization file construction instruction sequence;

a representation file construction instruction sequence;

a switching file construction instruction sequence.

In some example embodiments said initialization file construction instruction sequence includes instructions for a file type box, a progressive download information box, and a movie box.

In some example embodiments said representation file construction instruction sequence includes instructions to store segments of a representation as movie fragment boxes and associated media data boxes.

In some example embodiments said switching file construction instruction sequence includes instructions to reflect a switch from the reception of one representation to another in file structures.

In some example embodiments the method comprises creating the Initialization file construction instruction sequence for each potential combination of representations that a client may receive in one streaming session.

In some example embodiments the method comprises associating the Initialization file construction instruction sequence with a resource locator of said Initialization file construction instruction sequence.

In some example embodiments the method comprises creating the representation file construction instruction sequence samples for each representation of a group of representations.

In some example embodiments the method comprises creating the switching file construction instruction sequence samples for each pair of representations in the same group of representations.

In some example embodiments the method comprises creating instructions for storing a movie box, movie fragment boxes, and media data to the same file.

In some example embodiments the method comprises creating instructions for storing a movie box and movie fragment boxes to a first file, and for storing media data to a second file.

An apparatus according to a sixth embodiment comprises:

a recognizer configured for recognizing a first segment and a second segment;

a creator configured for creating a first instruction and a second instruction to indicate at least one modification of the first segment and the second segment such that at least one file can be created on the basis of the modified first segment and the modified second segment.

In some example embodiments the apparatus is configured for creating instructions that cause more than one file to be constructed for a single streaming session.

According to a seventh embodiment there is provided a computer readable storage medium stored with code thereon for use by an apparatus, which when executed by a processor, causes an apparatus to generate a first instruction and a second instruction, wherein the computer program product further comprises computer code to cause the apparatus to:

recognize a first segment and a second segment;

create a first instruction and a second instruction to indicate at least one modification of the first segment and the second segment such that at least one file can be created on the basis of the modified first segment and the modified second segment.

According to an eighth embodiment there is provided at least one processor and at least one memory, said at least one memory stored with code thereon, which when executed by said at least one processor, causes an apparatus to perform:

recognizing a first segment and a second segment;

creating a first instruction and a second instruction to indicate at least one modification of the first segment and the second segment such that at least one file can be created on the basis of the modified first segment and the modified second segment.

According to a ninth embodiment there is provided a method for indicating a first resource locator for a first instruction and a second resource locator for a second instruction, wherein

a first segment and a second segment are recognized,

the first instruction and the second instruction are recognized, the first instruction and the second instruction indicating at least one modification of the first segment and the second segment such that at least one file can be created on the basis of the modified first segment and the modified second segment,

associating the first resource locator to the first instruction and associating the second resource locator to the second instruction, and

indicating the first resource locator and the second resource locator in a media presentation description.

An apparatus according to a tenth embodiment comprises:

a first element configured for recognizing a first segment and a second segment;

a second element configured for recognizing a first instruction and a second instruction, the first instruction and the second instruction indicating at least one modification of the first segment and the second segment such that at least one file can be created on the basis of the modified first segment and the modified second segment;

a third element configured for associating the first resource locator to the first instruction and associating the second resource locator to the second instruction, and

a fourth element configured for indicating the first resource locator and the second resource locator in a media presentation description.

According to an eleventh embodiment there is provided a computer readable storage medium stored with code thereon for use by an apparatus, which when executed by a processor, causes an apparatus to indicate a first resource locator for a first instruction and a second resource locator for a second instruction, wherein the computer program product further comprises computer code to cause the apparatus to:

recognize a first segment and a second segment;

recognize a first instruction and a second instruction, the first instruction and the second instruction indicating at least one modification of the first segment and the second segment such that at least one file can be created on the basis of the modified first segment and the modified second segment;

associate the first resource locator to the first instruction and associating the second resource locator to the second instruction, and

indicate the first resource locator and the second resource locator in a media presentation description.

An apparatus according to a twelfth embodiment comprises:

means for receiving a first segment and a second segment;

means for receiving a first instruction and a second instruction;

means for modifying the first segment and the second segment on the basis of the first instruction and the second instruction; and

means for creating at least one file on the basis of the modified first segment and the modified second segment.

An apparatus according to a thirteenth embodiment comprises:

means for recognizing a first segment and a second segment;

means for creating a first instruction and a second instruction to indicate at least one modification of the first segment and the second segment such that at least one file can be created on the basis of the modified first segment and the modified second segment.

What is claimed is:

1. A method comprising:
receiving a first segment and a second segment,
receiving a first instruction and a second instruction,
modifying the first segment and the second segment on the basis of the first instruction and the second instruction,
creating at least one file on the basis of the modified first segment and the modified second segment.

2. The method according to claim 1 further comprising receiving media data in said first segment and said second segment.

3. The method according to claim 1, wherein said instructions belong to a file construction instruction sequence, wherein said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

4. An apparatus comprising at least one processor and at least one memory, said at least one memory stored with code thereon, which when executed by said at least one processor, causes an apparatus to perform:
receiving a first segment and a second segment,
receiving a first instruction and a second instruction,
modifying the first segment and the second segment on the basis of the first instruction and the second instruction,
creating the at least one file on the basis of the modified first segment and the modified second segment.

5. The apparatus according to claim 4 configured to receive media data in said first segment and said second segment.

6. The apparatus according to claim 4, wherein said instructions belong to a file construction instruction sequence and said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

7. The apparatus according to claim 6 configured for receiving said file construction instruction sequences in segments, wherein the apparatus is configured for receiving said initialization file construction instruction sequence in an initialization segment, and said representation file construction instruction sequence and said switching file construction instruction sequence in one or more media segments.

8. The apparatus according to claim 6 configured for using said switching file construction instruction sequence to contain instructions to reflect a switch from the reception of one representation to another in file structures.

9. A computer readable storage medium stored with code thereon for use by an apparatus, which when executed by a processor, causes an apparatus to generate at least one file comprising media data, wherein the computer readable storage medium further comprises computer code to cause the apparatus to:
receive a first segment and a second segment,
receive a first instruction and a second instruction,
modify the first segment and the second segment on the basis of the first instruction and the second instruction, and
create the at least one file on the basis of the modified first segment and the modified second segment.

10. The computer readable storage medium according to claim 9 further comprising computer code to cause the apparatus to include media data in said first segment and said second segment.

11. The computer readable storage medium according to claim 9, wherein said instructions belong to a file construction instruction sequence and said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

12. The computer readable storage medium according to claim 11 further comprising computer code to cause the apparatus to receive said file construction instruction sequences in segments, wherein said initialization file construction instruction sequence is received in an initialization segment, and said representation file construction instruction sequence and said switching file construction instruction sequence are received in one or more media segment.

13. The computer readable storage medium according to claim 12 further comprising computer code to cause the apparatus to use said switching file construction instruction sequence to contain instructions to reflect a switch from the reception of one representation to another in file structures.

14. A method comprising:
generating a first instruction and a second instruction;
creating the first instruction and the second instruction to indicate at least one modification of a first segment and a second segment such that at least one file can be created on the basis of the modified first segment and the modified second segment.

15. The method according to claim 14 further comprising including media data in said first segment and said second segment.

16. The method according to claim 14, said first and second instruction belonging to a file construction instruction sequence, wherein said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

17. The method according to claim 14 further comprising including a resource locator of said file construction instruction sequence in a media presentation description.

18. A computer readable storage medium stored with code thereon for use by an apparatus, which when executed by a processor, causes an apparatus to generate a first instruction and a second instruction, wherein the computer program product further comprises computer code to cause the apparatus to:
create a first instruction and a second instruction to indicate at least one modification of a first segment and a second segment such that at least one file can be created on the basis of the modified first segment and the modified second segment.

19. The computer readable storage medium according to claim 18 stored with code thereon for use by an apparatus, which when executed by a processor, further causes an apparatus to include media data in said first segment and said second segment.

20. The computer readable storage medium according to claim 18, said first and second instruction belonging to a file construction instruction sequence, wherein said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

21. The computer readable storage medium according to claim 20 further comprising including a resource locator of said file construction instruction sequence in a media presentation description.

22. An apparatus comprising at least one processor and at least one memory, said at least one memory stored with code thereon, which when executed by said at least one processor, causes an apparatus to:
create a first instruction and a second instruction to indicate at least one modification of a first segment and a second segment such that at least one file can be created on the basis of the modified first segment and the modified second segment.

23. The apparatus according to claim 22, said at least one memory stored with code thereon, which when executed by said at least one processor, further causes an apparatus to include media data in said first segment and said second segment.

24. The apparatus according to claim 23, said first and second instruction belonging to a file construction instruction sequence, wherein said file construction instruction sequence comprises at least one of the following:
an initialization file construction instruction sequence;
a representation file construction instruction sequence;
a switching file construction instruction sequence;
a finalization file construction instruction sequence;
a re-initialization file construction instruction sequence.

25. The apparatus according to claim 24, said at least one memory stored with code thereon, which when executed by said at least one processor, further causes an apparatus to include a resource locator of said file construction instruction sequence in a media presentation description.

26. A method comprising:
indicating a first resource locator for a first instruction and a second resource locator for a second instruction;
recognizing the first instruction and the second instruction, the first instruction and the second instruction indicating at least one modification of a first segment and a second segment such that at least one file can be created on the basis of the modified first segment and the modified second segment,
associating the first resource locator to the first instruction and associating the second resource locator to the second instruction, and
indicating the first resource locator and the second resource locator in a media presentation description.

27. A computer readable storage medium stored with code thereon for use by an apparatus, which when executed by a processor, causes an apparatus to indicate a first resource locator for a first instruction and a second resource locator for a second instruction, wherein the computer program product further comprises computer code to cause the apparatus to:
recognize a first instruction and a second instruction, the first instruction and the second instruction indicating at least one modification of a first segment and a second segment such that at least one file can be created on the basis of the modified first segment and the modified second segment;
associate the first resource locator to the first instruction and associating the second resource locator to the second instruction, and
indicate the first resource locator and the second resource locator in a media presentation description.

28. An apparatus comprising:
means for receiving a first segment and a second segment;
means for receiving a first instruction and a second instruction;
means for modifying the first segment and the second segment on the basis of the first instruction and the second instruction; and
means for creating at least one file on the basis of the modified first segment and the modified second segment.
